(19) United States
(12) Patent Application Publication
(10) Pub. No.: US 2013/0203027 A1
(43) Pub. Date: Aug. 8, 2013

(54) Adaptive Set Discrimination Procedure

(71) Applicants: Etienne De Villers-Sidani, Montreal (CA); Michael Merzenich, San Francisco, CA (US)

(72) Inventors: Etienne De Villers-Sidani, Montreal (CA); Michael Merzenich, San Francisco, CA (US)

(73) Assignee: THE REGENTS OF THE UNIVERSITY OF CALIFORNIA, Oakland, CA (US)

(21) Appl. No.: 13/704,918

(22) PCT Filed: Jun. 22, 2011
(86) PCT No.: PCT/US2011/041491

§ 371 Date: Apr. 10, 2013

Related U.S. Application Data
(60) Provisional application No. 61/359,296, filed on Jun. 28, 2010.

(51) Int. Cl. G09B 19/00

(52) U.S. Cl. CPC G09B 19/00
USPC 434/236

(57) ABSTRACT

The present disclosure relates to methods and tools to enhance cognition in an individual. The methods involve presenting to the individual multiple sets of stimuli (e.g. two or more sets). Each set of the multiple sets contains two or more background stimuli. Out of the multiple sets presented to the individual, at least one set also contains at least one anomalous stimulus and such set is referred to as the target set. The method then receives an input from the individual that has been instructed to respond to the anomalous stimulus in the target set.

### CROSS-REFERENCE TO RELATED APPLICATIONS

This application claims the benefit of U.S. Provisional application Ser. No. 61/359,296, filed on Jun. 28, 2010, which application is incorporated herein by reference in its entirety.

### STATEMENT REGARDING FEDERALLY SPONSORED RESEARCH

This invention was made with government support under Conte grant 5P50 MH077970-03 awarded by the National Institutes of Health. The government has certain rights in this invention.

### INTRODUCTION

Perceptual and cognitive decline are near-universal aspects of normal aging. Such deficits cannot be explained solely by a dysfunction of peripheral sensory organs and frequently translate to slowed perceptual processing and difficulty in accurately identifying stimuli under challenging (noisy, time-limited, attentionally-demanding) conditions.

For example, in the human auditory system, psychophysical and electro-encephalography experiments have examined aspects of cognitive decline using oddball detection paradigms, successive-signal masking studies, speech-in-noise studies, and compressed speech, among other strategies. These studies have shown that degraded signal salience, defective sensory adaptation, greater successive-signal masking, and a slowing of sensory processing contribute to the deterioration of a wide range of perceptual and cognitive processes recorded in aged populations. In the visual system, electrophysiological and functional magnetic resonance imaging studies have shown that top-down and local suppression deficits contribute to degraded signal salience, and to an increased susceptibility to distracters and impaired working memory performance. Psychophysical studies have again revealed a marked slowing of sensory processing in old brains.

Accordingly, methods and tools to improve cognition are of interest. The study of the present disclosure assessed the impact of an auditory training task specifically designed to improve frequency resolution and ability to distinguish “oddball” on a series of cortical processing abnormalities in the primary auditory cortex (A1) of healthy aging rats, as documented at the single-cell and cortical column and cortical network levels. Such training applied for one month, one hour per day, was found to result in a large-scale partial or complete reversal of more than twenty A1 age-related cortical alterations, which would appear to account for multiple dimensions of age-related cognitive loss, recorded in both rats and humans.

### SUMMARY

The present disclosure relates to methods and tools to enhance cognition in an individual. The methods involve presenting to the individual multiple sets of stimuli (e.g. two or more sets). Each set of the multiple sets contains two or more background stimuli. Out of the multiple sets presented to the individual, at least one set also contains at least one anomalous stimulus and such set is referred to as the target set. The method then receives an input from the individual that has been instructed to respond to the anomalous stimulus in the target set. The background stimuli are similar if not identical to each other in at least one or more properties and differ from the anomalous stimulus in at least one or more property (e.g. pitch). The methods repeat the presenting and the receiving steps, and can vary the difficulty in discerning the anomalous stimulus from the background by increasing or decreasing the difference between background stimuli and the anomalous stimuli, for example.

### BRIEF DESCRIPTION OF FIGURES

FIG. 1. Oddball discrimination training in young and aged rats. The performance of young (n=5) and aging (n=5) rats was determined in an oddball detection task. (a) In this Go-NoGo experimental paradigm, rats were rewarded for performing a behavioral response (nosepoke) only when an oddball tone was presented in a series of six otherwise identical tones. The difficulty level was increased by decreasing the frequency difference (AD between oddballs and standards every time three correct “hits” were performed. Lack of response to a target or a response to a series of six identical tones (foils) resulted in a “timeout”, and a decrease in the level of difficulty. (b) Average maximal level reached by young (full line) and aged (dotted line) adult rats as a function of training session number. (c) Average number of responses to targets over the total number of targets (hit ratio) in young and aged as a function of training session number. (d) Average number of responses to foils over the total number of foils (false positive rate) as a function of training session number. Error shown is s.e.m.

FIG. 2. Training and age-related changes A1 frequency representation. Panel a, Top row, representative A1 characteristic-frequency (CF) maps from all four experimental groups. Middle row, same A1 maps showing the representation of tuning curve width (BW10) and bottom row, receptive field (RF) overlap relative to the recording site shown by the star. Panel b, Representative cortical receptive fields from the CF maps shown in panel a. Note the decreased frequency selectivity of the neuron from the aged rat (3) compared to the young and trained groups. Panel c, Distribution of BW10 by CF all experimental groups. Panel d, CF of A1 neurons plotted against position on the normalized tonotopic axis (see Methods) of the corresponding recorded cortical site, for all groups (all recorded sites were pooled). The average tonotopic index (TI) calculated for each individual A1 map is shown for each group. Note the significantly greater TI value in the aged group (p<0.01) indicating a high degree of CF scatter in A1 (loss of smooth tonotopic gradient) and its significant partial correction after training (p<0.05). Panel e, Average RF overlap index (see Methods) as a function of inter-neuron distance for all experimental groups (all neuron pairs pooled in each group). Scale bar represents 0.75 mm. X, unresponsive cortical siteO, non-AI cortical site (see Methods); D, dorsal; C, caudal; R, rostral; V, ventral. (Young, n=14, number of sites=387; young-trained, n=5, number of site=211; aged, n=12, number of sites=291, aged-trained, n=5, number of sites=201). Values shown are mean±s.e.m. *: p<0.05, **: p<0.001: t-test.

FIG. 3. Improvement in temporal coding in trained aged rats. Panel a, Representative raster plots obtained for individual neurons in all four experimental groups for pulsed noise trains presented at various repetition rates. Panel b, Cumulative probability plot of the temporal following limit (F_{h1/2}) of neurons in each group. Panel c, Average repetition rate transfer function (RRTF) of A1 neurons in all groups. Note the decrease in firing rate modulation in the naïve-aged group. Panel d, Average asynchronous response rates as a function of noise train presentation rate showing the high level of neural responses not phase locked to the stimulus presented in aged rats. Panel e, Average confusion matrices for noise burst presentation rates expressed as misclassification rate and obtained using the Van Rossum spike train distance metric (see Methods) for young young-trained, aged and aged-trained subjects. (Young, n=10, number of sites=234; young-trained, n=4, number of sites=75; aged, n=8, number of sites=176, aged-trained, n=4, number of sites=86). Error bars are and s.e.m. *: p<0.05, **: p<0.001: t-test.

FIG. 4. Reversible cortical desynchronization in the aged A1. Mean cross-correlation functions for pairs of A1 neurons recorded simultaneously in silence in young, young-trained (panel a), aged and aged-trained rats (panel c) for inter-electrode distances of 1 mm and less. Panel b, Average peak correlation coefficient of as a function of distance in all experimental groups. (Young, n=10, number of site pairs=456; young-trained, n=4, number of site pairs=284; aged, n=8, number of site pairs=320, aged-trained, n=4, number of site pairs=268).

FIG. 5. Distracter suppression and novel stimulus discrimination in the aging A1. Panel a, Above, example of tone train use for recording containing random oddball tones with a ten percent probability. The difference in frequency (Δf) between oddball (red) and standard (gray) was constant at 1 octave. Both frequencies were chosen to fall within the receptive field of the neuron studied. Rate of presentation was constant for each trial and were (randomly) 1, 3 or 5 Hz. Panel a, Below, representative normalized responses of individual A1 neurons in the four experimental groups to standards and oddballs as a function tone position in the stimulus sequence. Panel b, Average values and standard error of the asymptotes and time constants (τ) of the exponential fits obtained for oddball and standard responses functions. Panel c, Average exponential fit for responses to oddballs (dotted lines) and standards (full lines) in young (Y), young-trained (YT), aged (A) and aged-trained (AT) at various rates of presentation. Panel d, Distribution of oddball to standard asymptote ratios for all neurons recorded in all four experimental groups. Note how the ratio is closer to one and increases with training in both trained groups but more noticeably in aged-trained. (Young, number of neurons studied=180; young-trained, number of neurons studied=56; aged, number of neurons studied=216, aged-trained, number of neurons studied=167). Error bars are and s.e.m. *: p<0.05: t-test with Bonferroni correction.

FIG. 6. Training-induced recovery in parvalbumin (PV) expression in the aging cortex. Low power photomicrographs demonstrating the distribution of PV immunoreactivity in A1 in young, aged and aged-trained rats. Note the decreased density of A1 PV+ neurons in the aged (Panel d), compared to young rat (panel a), and the expression recovery in the aged-trained (panel g). Higher magnification revealed the relatively high number of weakly labeled PV immunoreactive neurons (pointed by arrow heads) in the aged (panel e) compared to young (panel f), and aged-trained (Panel g). Reduced dendritic PV immunoreactivity (pointed by arrows) was also noted in the aged (panel f) compared to the young (panel c), and aged-trained (panel i). Semi-quantitative analysis on the number of PV+ cells is shown in (panel j), as well as the lightly stained PV+ cells (panel k). Number of hemispheres examined: young=14, aged=10, aged-trained=6. **: p<0.01: t-test. Error bars are s.e.m. Scale bar in panel G (apply for panels A and D): 200 μm; in H (apply for panels B and E): 100 μm; in I (apply for panels C and F):50 μm.

FIG. 7. Training-induced changes in cortical myelin basic protein (MBP) expression in the aging cortex. Representative low and high powers of MBP immunoreactivity of A1 in young (panels a and d), aged (panels b and e), and aged-trained (panels c and f) rats. Note the relative decrease in MBP staining in the superficial cortical layers (I-III) in the aged compared to the young, and aged-trained groups. The semi-quantitative analysis of MBP expression among the three experimental groups is shown in FIG. 7, panels g (layer I), h (layer II and III), and i (number of Olg+ cells). The brackets in a marked the cortical layers I, and II, III, respectively for the semi-quantitative density analysis. Scale bar in a (apply for panels b and c):300 μm; in panel d (apply for panels e and f): 100 μm. Number of hemispheres examined: young=6, aged=6, and aged-trained=6.

FIG. 8. Age-related changes in A1 sound intensity thresholds. Distribution of A1 sound intensity thresholds in young, young-trained, aged and aged-trained separated by characteristic frequency (CF). (Young, n=14, number of sites=387; young-trained, n=5, number of sites=211; aged, n=12, number of sites=291, aged-trained, n=5, number of sites=201). Values shown are mean±sem. *: p<0.05, t-test with Bonferroni correction.

FIG. 9. Impact of training on spectro-temporal interactions. Panel a, Left, average normalized spectro-temporal receptive fields (STRFs, inhibitory portion only) of all neurons recorded in each experimental group (see Methods). Note the smaller and shallower inhibitory area (blue) in aged-naïve and the recovery with training. The peak activation of each individual STRF was aligned to compute the average. Panel a, Right, total average strengths in activation and inhibition of the STRFs recorded. Panel b, Intensity of inhibition and spectral distribution of the main inhibitory peak relative to the main peak of activation in all the STRFs recorded in each group. Panel c, Temporal and spectral location of the main inhibitory peaks in all STRFs recorded. (Young, number of STRFs=55; young-trained, number of STRFs=59; aged, number of STRFs=47, aged-trained, number of STRFs=46). Error bars are and s.e.m. **: p<0.001: t-test.

FIG. 10. Age and training-related changes in A1 spatio-temporal receptive fields. Panel a, Representative spatio-temporal receptive fields (STRFs) obtained for single neurons in A1 in all four experimental groups. Note the smaller and shallower inhibitory areas (blue) in the aged group. Panel b, Distribution of neuron characteristic frequencies (CF) of the neurons from which STRFs were obtained.

FIG. 11. Differences in cortical responses to low probability stimuli. Panel a, Average difference between responses for standard and oddball tones (“mismatch negativity”, MMN) in both naïve (full lines) and trained groups (dotted lines). Note the small MMN in aged naïve that significantly recovers with training. Panel b, Average peri-stimulus time histogram (PSTH) for oddball and standard tones in all groups. The changes seen with training in the aged group traces show that the recovery of MMN shown in panel a is driven primarily by an increase in responses to oddball rather than a normalization of standard suppression. The arrows point at the late responses often observed after an oddball tone presentation. The average latency and scatter of these responses was significantly reduced after training in both age groups (see text). (Young, number of neurons studied=180; young-trained, number of neurons studied=56; aged, number of neurons studied=216, aged-trained, number of neurons studied=167).

FIG. 12. Panel a is a graphical representation of two auditory stimulus sets that contain only background stimuli. Panel b is a graphical representation of two auditory stimulus sets, in which the top set contains one anomalous stimulus and the bottom set contains two anomalous stimuli.

FIG. 13. Flow chart of an example of a method for cognitive training in accordance with the present disclosure.

### DETAILED DESCRIPTION OF EXEMPLARY EMBODIMENTS

The present disclosure relates to methods and tools that enhance cognition. Enhancing cognition includes improving the ability to discriminate an anomalous stimulus from a background.

Before the present invention and specific exemplary embodiments of the invention are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DEFINITIONS

When describing the methods and compositions of the present disclosure, the following terms have the following meanings unless otherwise indicated.

The term “cognition”, as used herein, refers to the speed, accuracy and reliability of processing of information, and attention and/or memory.

As used herein, the term “attention” refers to the facilitation of a target and/or suppression of a non-target over a given spatial extent, object-specific area or time window.

The term “gap” or “inter-stimulus-interval (ISI)”, refers to a specified amount of time between ceasing presentation of a stimulus and presenting a next stimulus in a sequence.

The term “emphasis level”, refers to a degree of distinguishability of the presented stimulus with respect to a background of stimulus.

The term “anomalous” or “oddball”, as used herein, refers to a stimulus that differs from a background of identical or similar stimuli. For example, for an auditory stimulus the difference may be in the loudness or pitch and for a visual stimulus, the difference may be in the shape or color.

### Stimulus

The present disclosure relates to methods and tools that enhance cognition. Enhancing cognition includes improving the ability to discriminate anomalous stimulus from background stimulus. Other benefits are listed in Table 1 in the discussion of the Example section, such as increased receptive field overlap and higher sound-intensity thresholds.

The method requires presenting to an individual stimulus sets. A stimulus set may be auditory, visual or olfactory. Below are descriptions of some examples of stimuli that can be used in the subject methods.

Auditory

An auditory stimulus refers to a sound and may be characterized by, for example: frequency, loudness (i.e., intensity), timbre, or any parametric combination of these or any other sound features. The duration of time a stimulus is presented to an individual can also be varied. For example, an auditory stimulus may be presented to an individual, e.g. for a fraction of a second (such as about 40 milliseconds (ms), about 50 ms, about 60 ms, about 70 ms or more), for a second or for a length between about 1 and about 2 seconds, or for up to about 2 seconds or more. An example of a duration of an auditory stimulus presentation is about 100 ms.

A stimulus can also be spectrally-complex stimuli like vowels, phonemes, syllables, or words. A stimulus can also be presented by a voice and as such characterized by the presenting voice (e.g. call of a specific bird). The auditory stimulus can also be characterized by a waveform that is defined by an amplitude (i.e. intensity or loudness) and a frequency or any other sinusoidal properties.

A background auditory stimulus can differ from an anomalous auditory stimulus in any one or more characteristics, such as frequency, loudness, or timbre, as well as properties of these characteristics. For example, if they differ in frequency, the difference in frequency may be measured in hertz or octave. Hertz (Hz) measures the numbers of cycle per second in the sound wave while octave represents frequency as pitch. One octave refers to the interval between a first pitch and a second pitch, in which the first and second pitch differs by double or half the frequency of the first pitch. An auditory stimulus presented in the subject method may be between about 20 Hz to about 100 Hz, about 100 Hz to about 500 Hz, between about 500 Hz to about 1000 Hz, between about 500 Hz to about 2000 Hz, between about 2000 Hz to about 5000 Hz, between about 2000 Hz to about 8000 Hz, between about 8000 Hz to about 10,000 Hz, between about 10,000 Hz up to about 20,000 Hz or more. For example, the stimuli provided in the subject method may have a frequency from about 1000 Hz to 3000 Hz or 1000 Hz to 6000 Hz.

The frequency difference between a background auditory stimulus and an anomalous auditory stimulus may be between about 0.01% to about 0.05%, between about 0.05% to about 0.1%, between about 0.1% to about 0.3%, between about 0.3% to about 0.5%, between about 0.5% to 1%, between about 1% to about 3%, between about 3% to about 6%, up to about 9% or more.

Where the difference between a background auditory stimulus and an anomalous auditory stimulus differs in loudness, the difference can be expressed in sound pressure level (SPL) measured in decibels (dB) above a standard reference level. The standard reference level is about 20 pPa. Where the auditory stimulus is represented as a waveform, loudness can be equivalent or proportional to the amplitude. The loudness difference between a background auditory stimulus and an anomalous auditory stimulus may be about 0.1 dB, about 0.5 dB, about 1 dB, about 2 dB, about 3 dB, about 4 dB, up to about 5 dB or more.

Background auditory stimulus may also differ from the anomalous auditory stimulus in timbre, which is the quality of a sound that distinguishes different types of sound production, such as voices or musical instruments. The physical characteristics of a sound that mediate the perception of timbre include spectral and time envelopes. Spectral envelope refers to the boundary and shape of waveform while the time envelope characterizes the rise, duration and decay of the wave. Timbre of a sound can also be referred to as tone quality or tone color. For example, the anomalous stimulus can differ from the background stimuli because it is presented by a call of a different bird of the same species, of a bird of another species, of a bird in another location, or any parametric variations thereof.

Other ways in which the background auditory stimulus may also differ from the anomalous auditory stimulus employ the various phonemes (e.g. vowels and consonants) in languages and combinations thereof that results in spoken words and/or syllables. For example, background stimuli can be specific phoneme while the anomalous stimulus can be a perceptually different but confusable phoenem or a different acoustic variant of the same phoenem. Details of how phonemes can be characterized can be found in U.S. Pat. No. 6,290,504, U.S. Pat. No. 6,261,101, and U.S. Pat. No. 6,413,098, disclosures of which are incorporated herein by reference.

Any of the characteristics of sound described above, and combinations thereof, can be one or more of the ways in which the background auditory stimulus may differ from the anomalous auditory stimulus.

Visual

A visual stimulus is made up of electromagnetic waves in the visible light spectrum and may be characterized by, for example: brightness, color, shape, surface texture, orientations (e.g. grating), location in a visual field, orthographic (e.g. textual), quantity or motions, as well as properties of these characteristics. Background visual stimulus may differ from the anomalous visual stimulus in one or more of the listed properties. For example, a visual stimulus may be the number “5” or a geometric shape of a triangle, or a red sphere. Another example of a visual target stimulus can be a face amidst a crowd of faces of different genders, of different ages, of different ethnicities, presented at different visual field locations, or any parametric variations thereof. A target stimulus can also be a visual image of a bird of a certain species amidst a background of birds of the same or other species and at different spatial locations. Images may also be rich so as to contain multiple shapes, colors, textures, etc, as seen in a photograph or digitally-generated picture. Additional examples of how an anomalous stimulus can differ from the background are provided below.

The anomalous stimulus can contain an object in a different location and/or context from the same object in background stimuli. The anomalous graphical element may not belong in the same category as the background elements. Different parts of an object may also be presented to the individual as stimuli in series, in which the individual needs to identify a part that does not appear in a correct location as the anomalous stimulus. A background image can constantly be presented in the individual, in which the individual needs to detect a change in the image as the anomalous stimulus. The anomalous stimulus can be made more and more similar (in physical/semantic attributes) to the background, as time passes to increase difficulty level.

Each stimulus may also be referred herein as a graphical element. The followings are some examples of an anomalous stimulus and its corresponding background stimuli. The anomalous stimulus to be detected could be a car (or person travelling at a different speed or in a different direction than a group of car (or people) moving in a similar fashion. Another example could be to detect a visually presented number or letter (“5” for example) in a sequence non-letter shapes similar in appearance.

Similar to an auditory stimulus, the visual stimulus can also vary by the duration of time it is presented to an individual. Each graphical element may be presented with a specific duration to an individual, e.g. for a fraction of a second, for a second or for a length between about 1 and about 2 seconds or for up to about 2 seconds or more.

Olfactory, Somatosensory, etc.

An olfactory stimulus is a chemical that can be bound by odorant binding protein or chemoreceptors. The odorant can be volatile and can diffuse in air to the nasal passages, for example. The olfactory stimulus may differ based on the type and the concentration of a chemical compound, or the odorant stimulus delivery time. Background odorants can be constantly presented to the individuals, in which the individual needs to detect a change in either of the odorant properties (type/concentration, duration) as the target stimulus. The target stimulus can be made more and more similar to the background stimulus as time passes to increase difficulty level.

Some common odorants include esters, terpenes, and aromatics. For example, an olfactory stimulus may be benzaldehyde, which is an almond-like fragrance to humans. In another example, the anomalous odorant stimulus to be detected (target) could be the smell of a spice (e g vanilla produced by the aromatic compound vanillin) that would be presented simultaneously with several other odorants having a smell associated with fruits. The fruit odors could be produced using ester such as octyl acetate (orange), isoamyl acetate (banana, pear) and pentyl butyrate (pear, apricot).

Similar to the auditory, visual and olfactory stimuli, somatosensory/tactile stimuli. somatosensory/tactile stimuli may be employed in the subject methods. Somatosensory stimuli can vary in several properties, such as vibration strength, duration, spatial location, frequency, and combinatinatorial patterns of these parameters. Somatosensory stimuli used can also include light touch, vibration, temperature, and joint position. Other somatosensory stimulus properties would include raised or depressed shapes or textures on a surface, vibration strength and frequency, or limb position in space. For example, one different and four identical raised dot patterns could be gently applied in random order to the five fingers of one hand. The individual would be instructed to identify the finger being presented the anomalous stimulus and/or to identify the qualities of the anomalous stimulus.

Stimulus Set

A stimulus set is a sequence of stimuli presented to an individual with the same or similar inter-stimulus-interval (ISI). The ISI of a set can often be a fraction of a second, such as about 600 milliseconds (ms), about 500 ms, about 400 ms, about 300 ms, about 200 ms, or about 100 ms or less. The stimulus set can be delivered at a speed measured in pulse per seconds (pps). The stimuli in a set can be presented in about 1, about 2, about 2.5, about 3, about 3.5, about 4, about 5, about 6, about 7, about 8, about 10, about 12, about 15, about 20, about 25, up to about 30 or more pps.

Each set contains at least two stimuli. For example, each set can contain about 3, about 4, about 5, about 6, about 7, about 8, about 9, about 10, about 15, about 20, or up to about 30 or more stimuli. Where the set is a target set, the set contains at least one anomalous stimulus and can contain about 2, about 3, up to about 4 or more anomalous stimuli. The number of anomalous stimuli is less than the number of background stimuli or the number of total stimuli in a target set. For example, the number of anomalous stimuli is at most about 30%, at most about 25%, at most about 20%, at most about 10% or less the total number of stimuli in a target set. The one or more anomalous stimuli can appear at any location within a stimulus set. Where a stimulus set contains 4 or more stimuli as an example, an anomalous stimulus can appear at any location after the third stimulus. Where a stimulus set contains 6 or more stimuli, the anomalous stimulus can appear at the fourth, fifth, and/or sixth location in the set.

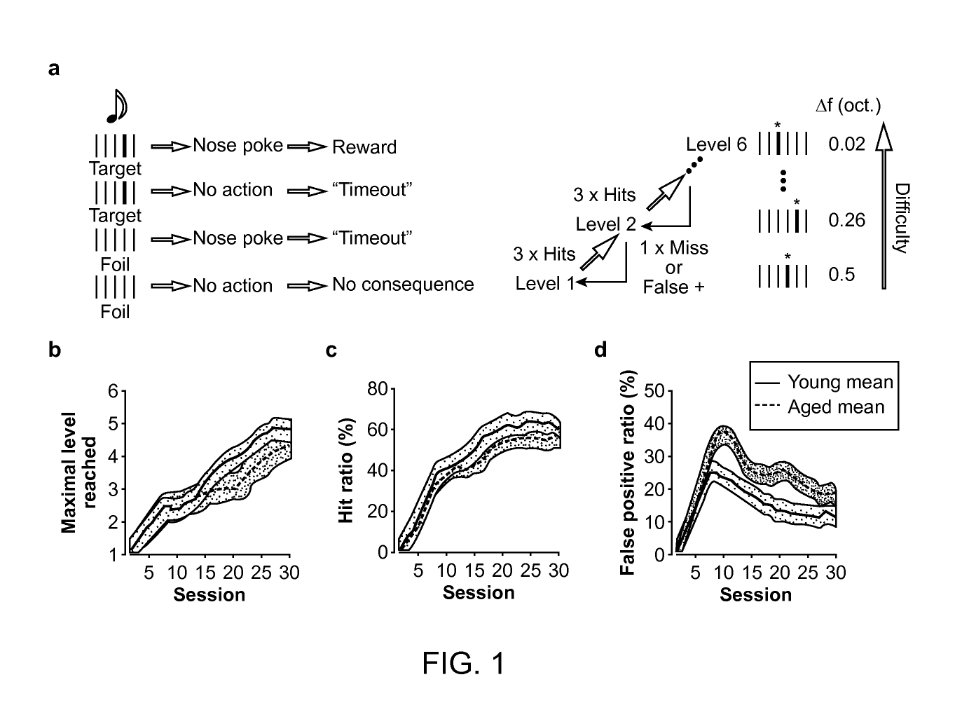

Alternatively, the subject methods can also be carried out where the stimuli are presented to an individual in a continuous stream, such that a training block contains one long set of stimuli with a specific ISI. In this way, there are no inter-set interval and no onset-to-onset time within a training block. The one or more anomalous stimuli can be presented with random occurrence in this stream. Where the stimuli within a training block are presented in a continuous stream, the background stimuli can be tonal or be acoustically complex (e.g. containing one or more different properties in one or more characteristics described above). The background stimuli can also be a noise (e.g. white noise). The properties in one or more characteristics of the background stimuli and/or anomalous stimuli can also vary after a discrete amount of time (e.g. after the individual has achieved 90% correct response rate).

Where the stimulus is auditory, all the background stimuli in a set may be identical or similar in one or more properties. See a graphical representation of a background auditory stimulus set in the figures (bottom two sets labeled as “foil” in FIG. 1, panel A and FIG. 12, panel A). For example, all the background stimuli may all be 9 kHz and 60 dB. Where the auditory stimulus set is a target set, the set contains one or more anomalous stimuli that differ from the background stimuli and each can be presented at a random location in the sequence. As noted above, the anomalous stimulus can differ from the background in a number of different ways. For example, the anomalous stimulus can be 12 kHz instead of the 9 kHz as the background stimuli. See graphical representations of a target stimulus set in the top two stimulus set of FIG. 1, panel A and in FIG. 12, panel B.

Similarly, a visual stimulus set presents a sequence of graphical elements to an individual in which the set can contain exclusively of background stimuli or contain one or more anomalous stimuli. A visual set is a sequence of graphical elements with the same or similar inter-stimulus-interval (ISI) in the same fashion as described above for an auditory stimulus set. For example, each graphical element may be presented for duration of about 1 second with an ISI of about 1 second. For example, an individual may be presented with a red triangle for a number of times as a background visual stimulus set. In a corresponding example where the visual stimulus set is a target set, the individual may be presented with a yellow square in a random location in a sequence of red triangles.

A stimulus set can also contain a combination of stimuli of different sensory systems. For example, a stimulus set may combine both auditory and visual stimuli. The set may present a sequence of auditory and visual stimuli that can be synchronized or unsynchronized. A target set can contain either an anomalous auditory or an anomalous visual stimulus or both. For example, where the background stimulus set contains an red triangle in clockwise rotation as well as an auditory stimulus of a vowel, a target stimulus set can contain a red triangle in counterclockwise rotation with an auditory stimulus that is the same or different from that of the background.

### Methods

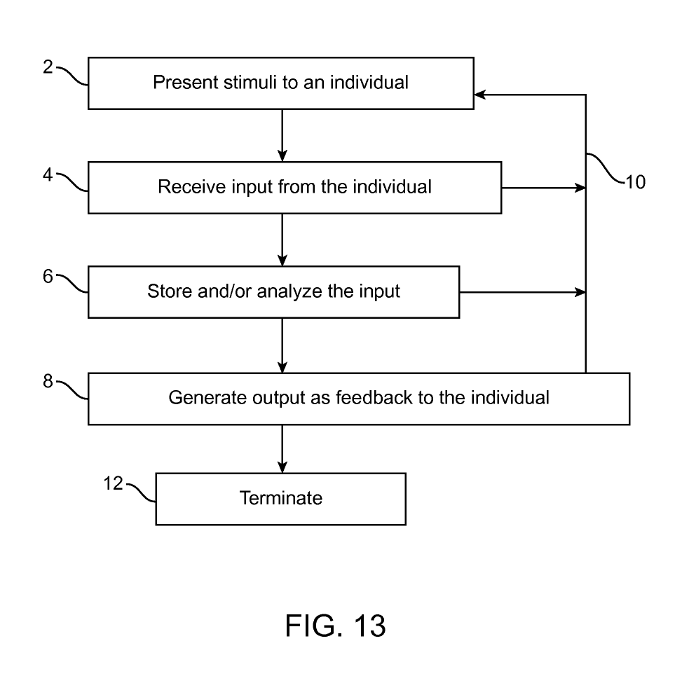

As noted above, the methods of the present disclosure enhances cognition in an individual by presenting to the individual stimulus sets, which may be auditory, visual, olfactory, somatosensory or a combination thereof, as described above. With reference to FIG. 13, the subject methods involve presenting 2 to an individual multiple sets of stimuli (e.g. two or more sets). Each set of the multiple sets contains two or more background stimuli. A set that contains exclusively of background stimuli are referred to as background sets or foils. In the multiple sets presented to the individual, at least one set contains at least one anomalous stimulus and such set is referred to as a target set. The method also receives 4 an input from the individual that has been instructed to respond to the anomalous stimulus in the target set. As discussed above, the background stimuli are similar if not identical to each other in at least one or more properties and differ from the anomalous stimulus in at least one or more property (e.g. pitch).

In multiple sets, the inter-set interval and the onset-to-onset time are longer than the inter-stimulus-interval (ISI) described above. The inter-set interval can be less than about 1, about 1, about 2, about 3, about 4, about 5, about 9, up to about 10 or more seconds in length. The time interval between the first stimulus of one stimulus set and the first stimulus of the next stimulus set that immediately follows is referred to as “onset-to-onset time”. Onset-to-onset time is often a fraction of a second and is more than ISI. Examples of onset-to-onset time can be about 1 sec, 600 milliseconds (ms), about 500 ms, about 400 ms, about 300 ms, about 200 ms, or less.

The subject methods also encompass repeating 10 the aforementioned steps of presenting 2 the multiple sets of stimuli and receiving 4 an input from the individual, in which a presenting step 2 and a receiving step 4 combine to form a cycle. The cycle may optionally include other steps, such as storing and analyzing the inputs 6 and generating an output 8 as shown in FIG. 13, and described later below. As such, the cycle may be repeated 10 after any one of the following step 4, 6, or 8. The time lapse between each cycle may be longer than or the same as the inter-set interval. The time interval between each repeating cycle and the number of cycles can be selected to tailor to different training blocks.

The cycles can be iterated with the same stimuli or different stimuli. For example, where the stimuli are auditory, the background stimuli and the target stimuli may be the same or different in one or more properties (e.g. loudness) as the corresponding stimuli in the previous cycle. In another example, any cycle of the subject methods can be exclusively auditory, exclusively visual, or a combination of both in any location in an iteration sequence. Thus, one cycle may differ from the previous cycle because one is auditory and the other is visual. There may also be two or more consecutive cycles in which the stimuli are exclusively auditory, exclusively visual, or a combination of both.

A training block repeats a number of cycles (e.g. two or more) to achieve a predetermined goal. A predetermined goal may be dependent on the responses of the individual or the length of the training block. For example, a training block may repeat as many cycles as it is necessary to receive a threshold percentage of correct response in the most recent number of cycles. The training block can also repeat until the percentage of correct response in a number of cycles is at or below a threshold. As an example, the training block may terminate 12 when the percentage of correct responses received from an individual is about 98% or more in the last 5 minute or the last 10 cycles. Alternatively, the training block may terminate 12 when percentage of correct responses is about 40% or less. A pre-determined threshold, such as a number of consecutive incorrect responses, can also halt the training block. In another example, the training block may repeat as many cycles for a select duration of time (e.g. about 5 minutes, about 10 minutes, about 15 minutes, about 20 minutes, about 30 minutes, up to about an hour or more).

The method also includes repeating training blocks. The time lapse between training blocks can range from a few seconds, an hour, a day, or more. Accordingly, the individual may receive a training block a specified number of times each day, for a specified number of days. In other words, the individual may go through a plurality of training blocks with a selected frequency (e.g. one block daily) over a period of days or months (e.g. 6 months) to improve cognition.

The difficulty level of each cycle and/or training block can differ when the subject methods include repeating cycles and/or repeating training blocks. As such, difficulty levels can change inter- or intra-training block. If an individual achieves a designated level of success (e.g. a pre-determined percentage of correct responses), the difficulty of the cycle and/or training block may be increased relative to the previous cycle and/or training block. Conversely, if the individual achieves a designated level of failure or fails to achieve a level of success, the difficulty of the cycle and/or training block may be decreased or remain the same relative to the previous cycle and/or training block. The level of success can also be measured alone or in combination with other indices, e.g. amount of time for an individual to respond after the presentation of a target stimulus. Other indices of performance can include, for example, reaction time, response variance, correct hits, omission errors, false alarms, signal detection d-prime, learning rate, and/or performance threshold, etc. Where the subject methods involve presenting stimuli in a continous stream in a training block, the difficulty level can change at random locations within the training block.

In an initial cycle and/or training block, the individual can be presented with a default difficulty level and the difficulty level can increase, decrease, or remain the same until the training block terminates after having attained a predetermined goal. A difficulty level can be increased in a number of the following ways. One way is to decrease the window of response, which is the time period between the moment a stimulus set is presented and the onset of the subsequent stimulus set. The window of response can be the onset-to-onset time. Alternatively, the window of response can also be the time period between the moment a stimulus set is presented and a discrete amount of time afterwards that the method allows for receiving the input. The individual has this window of time to respond as instructed. Hence, decreasing the ISI (i.e. increasing the pulse per second), the duration of the stimulus, decreasing the inter-set interval, or a combination thereof are ways to increase difficulty.

Another way to increase difficulty is to minimize the difference between background stimuli and the anomalous stimuli. For example, an anomalous auditory stimulus that differs from background auditory stimuli by about 1% in frequency is more difficult than if the frequency difference is 3%. In a related example where frequency is varied to increase difficulty levels, the difference in frequency between anomalous and background stimuli is reduced in base 2 logarithmic steps starting at 0.5 octaves for level 1 difficulty to 0.02 octaves at level 6 difficulty.

One other way to vary difficulty level is to change the duration of the stimulus, of the cycle, of the training block. Where the subject methods present stimuli in a continuous stream, a training task variable to modulate difficulty level can be the length of the continuous stream of stimuli. For example, the length of the continuous stream in a training block may be about 5 minutes, about 10 minutes, about 15 minutes, about 20 minutes, up to about 30 minutes or more.

Another way to increase difficulty level is to combine stimuli from different senses (e.g. visual and auditory). An additional way to vary difficulty is to increase or decrease the loudness of the stimuli. Alternatively, a variable that can be employed is the frequency of appearance of the target stimuli.

Where the stimuli are visual, the following are descriptions of how some variables can change within a cycle or a training block to change difficulty levels. One example is to morph images so that the anomalous graphical element becomes more and more similar to the background stimuli. Where the individual needs to detect an anomalous stimulus appearing in a background image, the anomalous stimulus can be made more and more similar (in physical/semantic attributes) to the background as time passes.

Any one or combinations of ways to increase difficulty can be used in the subject methods.

The difficulty level can be adjusted as frequently as needed and can also be tailored for a predetermined goal or the ability of the individual. The individual can start at the lowest difficulty level for the first training block on each day, at the difficulty level determined by previous training blocks, or at the difficulty level of their choosing. The individual may be presented with the same difficulty level cycles and/or training blocks until a certain level of success or failure is reached. The difficulty level can also decrease, increase, or remain the same, regardless of the performance of the individual. The methods can also be specifically tailored to the individual by maintaining around a threshold success rate for the individual, e.g., using a single stair maximum continuous performance likelihood procedure. For example, the methods can be tailored to target a constant error rate from an individual (e.g. approximately 80% correct trial response accuracy). Accordingly, with reference to FIG. 13, difficulty level can change after step 4, step 6, or step 8 depending on the predetermined goal.

The method may further include performing a trial block, where the trial block includes cycles of varying difficulty levels, and varying stimulus types, not necessarily in any order for the purposes of diagnosing the cognitive and/or sensory ability of the individual prior, during, and/or post-training.

The methods can further include presenting to the individual instructions relating to a description of the anomalous stimulus or presenting the actual anomalous stimulus. Instructions can encompass a demonstration of the type of stimulus to be presented and how to input a response. For example, the instructions can provide an exercise to familiarize the individual with the procedures of receiving the presentation of stimuli and with the procedures of inputting a response. The instruction can include details on the types of responses expected from the individual when presented with an anomalous stimulus or in the absence of an anomalous stimulus. The response can be a physical action of clicking a button and/or moving a cursor to a correct location on a screen, head movement, vocal response, eye movement, etc. Input or response from an individual received by the methods of the present disclosure involves a voluntary initiation of an action on the part of the individual and excludes measurements that may be obtained from an individual passively. For example, brain waves, such as those obtained in magnetoencephalography, are not considered as an input from an individual in the present disclosure.

With reference to FIG. 13, the present method can further include determining and/or categorizing the responses provided by the individual's input 6, and generating output 8 to the individual, e.g. visually or audibly. The types of responses/input that can be received from the individual and some examples of output are described in more detail below.

Hit (true positive): If the individual correctly indicates the presence or absence of one or more anomalous stimuli in a stimulus set, the response is considered to be a hit. The response would also have to be received within the window of response. For example, the response could be an input via a user interface into a computer, remotely or locally. When the individual's response is a hit (true positive) the individual may receive a feedback or output. The output may be a reward and can take various forms: auditory feedback, such as a success sound (e.g., a “ding”), visual feedback (e.g., a graphical success indication), addition of points, and/or bonus meter advances.

Non-response (true negative): If the individual correctly refrains from indicating the presence of an anomalous stimulus in a stimulus set, i.e. due to the absence of an anomalous stimulus, the individual's response is a non-response or true negative. The individual may be rewarded an output as described above for true positives. Output can include bonus meter advances, and after five non-responses in a row, for example, may be rewarded with auditory feedback, e.g., a success sound (e.g., a “ding”), visual feedback (e.g., a graphical success indication, progression of levels, such as a displayed “checkmark”), and/or addition of points.

False positive (false alarm): if the individual incorrectly identifies that a background stimulus in a stimulus set is anomalous, the individual's response is a false positive. In this case, the individual may receive a penalty as an output. The penalty can also take on the forms as described above: auditory feedback, such as an error sound (e.g., a “thunk”), visual feedback (e.g., a graphical indication of error or failure), bonus meter reset (where progress toward a bonus is reset to zero or decreased), lack of point addition, or subtraction of points.

Miss (false negative): If the individual incorrectly failed to indicate the presence or absence of one or more anomalous stimuli in a stimulus, the individual's response is a false negative. The subject may be penalized as described above for false positive responses with a bonus meter reset (where progress toward a bonus is reset to zero or decreased). Where the stimulus is visual, frame color may change, i.e., the graphical user interface (GUI) may modify the color of the region around the anomalous stimulus or stimulus set to indicate an error. Other rewards or penalties may be used as desired, e.g., visual feedback, e.g., an “X” under the stimulus, resetting the bonus meter, and so forth.

If the response is unclear such that it cannot be categorized by the computer or other tools carrying out the subject method, the response can be categorized as false positive, false negative, or simply as an uncategorized/undetermined response.

Aside from determining the correctness or incorrectness of the individual's response, the method can also analyze, store, and output the reaction time for the response and/or statistical measures for the individual's performance (e.g. percentage of correct or incorrect response in the last number of cycles, over a specified duration of time, or specific for a type of background and/or anomalous stimuli, etc.).

Not all outputs described above are to be presented to the individual after each cycle. Alternatively, one or more outputs may be generated at the end of each training block or at the end of several training block. When and what output is generated can also be pre-determined by the individual and/or the operator of the training program.

The methods of the present disclosure may also be combined with other methods that aim to enhance cognition. For example, the training blocks of the subject method can alternate with training block of a second method for a combination training regimen.

The method may be designed to be presented to an individual in a form of game or challenge, in which instructions to an individual include game objectives and individual's input are scored. For example, a correct response increases points whereas the score remains unchanged or decreased in points if the response is incorrect.

The methods of the present disclosure encompass the addition of engaging game elements that are integrated with the training block. These game elements confer substantial benefits to the user or the training program. One benefit is that the game context may encourage the user to engage more attentional resources to task, which can be critical for enhancing cognition. Additionally, the game context can provide incentives for a user to pay attention and/or complete the training. In other words, the interest and goal orientation created by the game context provide incentive to continue training for longer periods of time than would generally be supported by the less engaging training task on its own. Game specific features that can increase incentive and interest of an individual may include but not limited to bonus points, in-game reward or penalty, such as a graphical or auditory representation thereof, rewards or penalties that scale with difficulty level or time spent, real life rewards, etc.

### Target Population

The methods and tools of the present disclosure can be useful for any individuals, especially those interested in enhancing cognitive abilities.

Individuals that can benefit from the subject methods and tools include but not limited to adults, such as aging adults. For example, the subject methods and tools can be useful for adults that are about 40 years told, about 50 years old, about 60 years old, about 70 years old, up to about 80 years old or older. Measurable deterioration of cognitive abilities in an individual is common as he or she ages. The experience of this decline may exhibit as an occasional oversight in various tasks and/or increasing difficulty in concentration. The decline often progresses to more frequent lapses as one ages in which there is passing difficulty performing tasks requiring extraction of visual or auditory information from an environment quickly and accurately. Avoiding dangers when driving a car, scanning a crowd for a familiar face, and reading quickly are a few of such examples.

Such decline typically accelerates at age 50 and older and over subsequent decades, such that these lapses become noticeably more frequent. It is often clinically referred to as “age-related cognitive decline”. While often viewed (especially against more serious illnesses, e.g. Alzheimer's) as benign, such predictable age-related cognitive decline can severely alter quality of life by making daily tasks.

Age-related cognitive decline can lead to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The subject methods and tools have the potential to reverse and/or prevent the onset of this devastating neurological disorder in humans, such as those suffering or at risk for MCI.

Aside from age-related cognitive decline, people of all ages who experience or are at risk for cognitive impairment can benefit the subject methods and tools. For example, the subject methods are useful for training individuals whose cognitive losses have arisen as a consequence of injury, medical treatments, or chronic neurological or psychiatric illness. Specific examples that can cause cognitive impairment include traumatic brain injury, stroke, brain infections (AIDS, Lyme Disease, West Nile Virus, malaria, et alia), ‘chemobrain’, losses due to periods of anoxia due to surgery or injury, diffuse brain damage attributable to alcohol or drugs, etc. Cognitive losses of developmentally impaired child and adult populations can also be reversed by the subject method.

For individuals suffering from chronic neurological and psychiatric illness, changes in inhibitory neuron populations, myelination, response slowing, emergent response dis-coordination, degradation of response selectivity in spatial, spectral and temporal detail, and the degradation of the distinctions between background and anomalous stimuli are very similar to the effects of age-related cognitive decline. Accordingly, individuals of any age with profiles of cognitive impairment that parallel those in aging are target populations for the methods and tools of the present disclosure. The individuals can experience substantial ‘corrective’ neurological changes if trained by the subject methods.

### Computer System and Tools

The present disclosure provides computer program products that can carry out the subject method of enhancing cognition. The subject matter described herein may be embodied in systems, apparatus, methods, and/or articles depending on the desired configuration. In particular, various implementations of the subject methods described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g. keyboard and/or mouse), and at least one output device (e.g. speaker, headphones, and/or display).

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal.

Similarly, systems of the present disclosure may include a processor, such as CPUs, and a memory coupled to the processor. The system further includes a user interface (e.g. GUI) and one or more communication buses for interconnecting these components. The user interface includes at least one or more actuators (e.g. display or speakers) and one or more sensors, and may also include one or more feedback devices. For example, speakers or headphones may provide auditory prompting and feedback to the individual during execution of the computer program. Input devices such as a mouse or keyboard allow the individual to navigate the computer program, and to select particular responses after visual or auditory prompting by the computer program.

The memory may include one or more programs that cause the processor to perform one or more of the operations of the methods described herein. Memory may include high speed random access memory and may also include non-volatile memory, such as one or more magnetic disk storage devices. Memory may include mass storage that is remotely located from the central processing unit(s). The memory stores an operating system (e.g., Microsoft Windows, Linux or UNIX), an application module, and may optionally store a network communication module. Although a number of different computer platforms are applicable to the present disclosure, embodiments of the present invention execute on either IBM compatible computers or Macintosh computers, or similarly configured computing devices such as set top boxes, PDA's, gaming consoles, etc.

As noted above, the system may optionally include one or more networks or other communications interfaces, such as a network interface for conveying testing or training results to another system or device. The computer network contains computers, similar to the one described above, connected to a server. The connection between the computers and the server can be made via a local area network (LAN), a wide area network (WAN), or via modem connections, directly or through the Internet. A printer may also be connected to the computer in a network to illustrate that an individual can print out reports associated with the computer program of the present disclosure. The computer network 200 allows information such as test scores, game statistics, and other data pertaining to an individual's performance to flow from one computer to another, e.g. a server. Data pertaining to an individual's performance can include, fore example, reaction time, response variance, correct hits, omission errors, false alarms, signal detection d-prime, learning rate, and/or performance threshold, etc. An administrator can review the information and can then download configuration and data pertaining to a particular individual, back to the individual's computer. Alternatively, or additionally, the server may execute the computer program, and the individual may interact with the program via the individual's computer, e.g., in a client/server relationship.

As noted above, the individual may perform the training exercise via a graphical user interface (GUI), whereby graphical elements and/or sounds are presented to the individual and whereby the individual may provide responses. For example, the GUI may include the visual field within which various images, e.g., target stimulus set, may be displayed in sequence to the individual, as well as various on-screen buttons or controls whereby the individual may interact with the training exercise. For example, the display may provide a start button in which the participant may press (e.g., click on) to begin or resume a training block. Additional GUI elements may also be provided, e.g., for indicating various aspects of the individual's progress or status with respect to the exercise or task, such as the difficulty level of the current training block. Examples include a bonus meter (or equivalent), which may indicate the number of correct responses in a row, a graphical element that flashes, a program that plays music, and/or award bonus points, when some specified number, e.g., 5, of correct responses is attained.

The application module executing the subject method may include one or more of the following: a) a stimuli generation control program, module or instructions, for generating multiple sets of stimuli, as described above for the subject method; b) an actuator or display control program, module, or instructions, for producing or presenting the multiple sets of stimuli to an individual; c) a sensor control program, module or instructions for receiving input by extracting raw data in the sensor signals indicative of the individual's response; the sensor control program, module or instructions may also include instructions for controlling operation of the one or more sensors; d) a measurement analysis program, module or instructions, for analyzing the individual's responses to produce measurements and analyses, as discussed above; and e) a feedback program, module or instructions, for generating feedback signals as output for presentation to the individual via the one or more actuators or feedback devices.

The application module may furthermore store data, which includes the measurement data for an individual, and optionally may also include analysis results and the like. The application module may also store data derived from theoretical users or actual users other than the individual. Such data may be used as normative data from one or more control groups of individuals, and optionally may also include analysis results, and the like, based on the measurement data from the one or more control groups. Any of the programs described above may be stored or executed from more than one locations, e.g. more than one computer readable medium. For example, the stimuli generation program may be executed remotely via a network while the measurement analysis program may be stored and/or executed locally.

As noted above, the subject method can be employed as computer-based exercises and tasks in order to renormalize and improve the participant's cognition, e.g., the efficiency and capacity of visual and auditory attentional processings. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results.

In one embodiment, for example, there is provided a computer-readable storage medium, comprising instructions executable by at least one processing device that, when executed, cause the processing device to: (a) present to an individual with multiple sets of stimuli, wherein each set of said multiple sets comprises two or more identical stimuli, and wherein at least one set of said multiple sets comprises an anomalous stimulus; (b)_receive an input from said individual; (c) repeat said presenting and said receiving as a cycle; (d) repeat said cycle with a selected time interval in between cycles; and (e) determine if a subsequent cycle should have a higher difficulty level or a lower difficulty level based on the received input. The computer-readable storage medium may further comprising instructions executable by at least one processing device that, when executed, cause the processing device to: (1) present said multiple sets in a continous stream; (2) vary the difficulty level by varying pulse per section or onset-to-onset time; and/or (3) generate an output to said individual based on the input. In alternative embodiments, said output is a reward or a penalty. The stimuli may be auditory and the anomalous stimulus may differ in frequency, loudness, or timbre. Alternatively, the stimuli may be visual, the anomalous stimulus may differ in color, shape, size, texture, orientation, or motion. In one embodiment, the multiple sets may comprise at least 6 stimuli, and if the set of at least 6 stimuli is a target set, an anomalous is presented at position 3 or thereafter in said set.

The following examples further illustrate the present invention and should not be construed as in any way limiting its scope.

### EXAMPLES

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### Materials and Methods

The following methods and materials were used in the Examples below.

Mapping The Auditory Cortex

All procedures were approved under University of California San Francisco Animal Care Facility protocols. Nineteen male young (6-12 months old) and seventeen male aged (26-32 months old) Brown-Norway rats obtained from the National Institute on Aging (NIA) colony were used for this study. These rats were housed in pairs and wooden objects, plastic tunnels and toys were added to the cage for enrichment. Nuts and other food elements appreciated by this specie supplemented their diet on an intermittent basis. Experimental animals and untrained controls were slightly food deprived to increase exploratory behavior and motivation to perform the food-rewarded training task. Their weight was not allowed to decrease by more than ten percent of their initial weight. Their auditory environment consisted mainly of sounds and vocalizations produced by nearby rats of the colony. Background noise levels were negligible in the housing area. Young and aged rats were kept for at least one month in this environment before any manipulation.

For mapping, the rats were pre-medicated with atropine sulfate (0.02 mg/kg) to minimize bronchial secretions and with dexamethasone (0.2 mg/kg) to minimize brain edema. They were then anesthetized with pentobarbital (35-60 mg/kg, i.p.). Supplemental doses of dilute pentobarbital were given as required to maintain the rat in an areflexic state while preserving a physiological breathing rate. The cisterna magnum was drained of cerebrospinal fluid to minimize cerebral edema. The skull was secured in a head holder leaving the ears unobstructed. The right temporalis muscle was reflected, auditory cortex was exposed and the dura was resected. The cortex was maintained under a thin layer of silicone oil to prevent desiccation. Recording sites were marked on a digital image of the cortical surface.

Cortical responses were recorded with tungsten microelectrodes (1-2 MOhm; FHC, Bowdoinham, Me.). Recording sites were chosen to sample evenly from the auditory cortex at inter-electrode distances of 125-175 m. At every recording site, the microelectrode was lowered orthogonally into the cortex to a depth of 470-600 μm (layers 4/5), where vigorous stimulus-driven responses were obtained. The neural signal was amplified (10,000×), filtered (0.3-3 kHz), and monitored on-line. Acoustic stimuli were generated using TDT System III (Tucker-Davis Technology, Alachua, Fla.) and delivered to the left ear through a calibrated earphone (STAX54) with a sound tube positioned inside the external auditory meatus. A software package (SigGen and Brainware; Tucker-Davis Technology, Alachua, Fla.) was used to generate acoustic stimuli, monitor cortical response properties on-line, and store data for off-line analysis. The evoked spikes of a single neuron or a small cluster of neurons were collected at each site.

Frequency-intensity receptive fields (RF) were reconstructed by presenting pure tones of 50 frequencies (1-30 kHz; 0.1 octave increments; 25 ms duration; 5 ms ramps) at eight sound intensities (0-70 dB SPL in 10 dB increments) to the contralateral ear at a rate of tone stimulus per second. Repetition rate transfer functions (RRTF) were obtained by presenting trains of broadband noise bursts (25 ms duration; 5 ms ramps) at 70 dB SPL and at various rates (2.5-17.4 pulses per second). Spontaneous activity from single neurons for cross-correlation analysis was obtained with simultaneous recording from 4 electrodes positioned in A1 at variable inter-electrode separations. Adaptive gain control (response modulation to oddballs and standards) was measured using a similar procedure to the one used by Nelken (Ulanovsky, N., Las, L. & Nelken, I. (2003) Nat Neurosci 6:391-398). One to five minute-long trains of tones pips with of 25 ms duration pips were presented at 1, 3 and 5 pulses per second at a sound intensity of 70 dB SPL. Each train had a frequently occurring frequency (standard) with a probability of occurrence of 90% and a pseudo-randomly distributed oddball frequency presented 10% of the time with no repetition. The two frequencies in the train had constant separation of 1 octave and were chosen so they would be contained within the RF of the recorded neuron and elicit strong reliable spiking responses.

The stimulus used to obtain STRFs was created in a similar fashion than previously published (Blake, D. T. & Merzenich, M. M. (2002) J Neurophysiol 88:3409-3420) by adding independent tone pip trains at each ⅙th octave frequency bands between 1.5 and 22 kHz. An octave is a doubling of frequency. Tone pips in each independent train were 50 ms long with 5 ms on and off ramps and occurred following a Poisson distribution with an average of one pip per second. The spectro-temporal density stimulus was presented continuously for 15 minutes.

Behavior

The operant learning paradigm described below was designed according to standard published procedures (Polley, D. B., Steinberg, E. E. & Merzenich, M. M. (2006) J Neurosci 26: 4970-4982). Lightly food deprived young adult or aging rats were rewarded with a food pellet for making a “Go” response shortly after the presentation of a target stimulus. The target stimulus contains a train of six tone pips with five identical 9 kHz tones (standard, “Frequency 1”) and one tone of different frequency randomly distributed in any of the last four positions of the sequence (oddball, “Frequency 2”). The tones were presented at a 60 dB sound pressure level (SPL). Training was performed in an acoustically transparent operant training chamber (20×20×18 cm, length×width×height) contained within a sound-attenuated chamber. The rats were shaped in three phases. During phase A, rats were trained to make a nose poke response to obtain a food reward. During phase B, rats were trained to make a nose poke only after presentation of an auditory stimulus (single 12 kHz tone pip at 60 dB SPL). During phase C, the actual training program, rats were trained at level 1 to make a nose poke only for the target stimulus (containing an oddball frequency) and not for a foil stimulus with 6 identical tones of frequency identical to the standard frequency (9 kHz). Rats were advanced to higher difficulty levels (levels 2-6). For higher difficulty levels, the difference in frequency between the oddball and the standard was reduced in base 2 logarithmic steps starting at 0.5 octaves for level one to 0.02 octaves at level 6. Once rats were working within the actual training program, they began each day on level 1.

A single behavioral trial was defined as the length of time between the onsets of two successive tone trains. The inter-trial interval was selected at random from a range of 3-9 s. A rat's behavioral state at any point in time was classified as either “Go” or “NoGo.” Rats were in the Go state when the photobeam was interrupted. All other states were considered NoGo. For a given trial, the rat could elicit one of five reinforcement states. The first four states are given by the combinations of responses (Go or NoGo) and stimulus properties (target or non-target). Go responses within 3 s of a target were scored as a hit; a failure to respond within this time window will be scored as a miss. A Go response within 3 s of a non-target stimulus was scored as a false positive. The absence of a response was scored as a withhold. A hit triggered the delivery of a food pellet. A miss or false positive initiated a 5 s “time-out” period during which time the house lights were turned off and no stimuli were presented. A withhold did not produce a reward or a time out. The rats moved up one level of difficulty when three consecutive hits had been recorded. A miss or false positive brought them down one difficulty level (staircase procedure).

Psychometric functions and stimulus target recognition thresholds were calculated for each training block by plotting the percentage of Go responses as a function of the total number of target stimuli (hit ratio) and the percentage of false positives as a function of the total number of foils (false positive ration). Learning curves were reconstructed by plotting maximal level reached over successive days of training.

Immunohistochemistry

At the end of recording sessions, electrolytic lesions were made at the previously functionally defined A1 borders. All subjects were then received a high dose of pentobarbital (85 mg/kg i.p.) and perfused intracardially with saline followed by 3.5% paraformaldehyde in 0.1 M phosphate-buffered saline (PBS) at pH 7.2. Brains were removed and placed in the same fixative containing 20% sucrose for 12-24 hr. Fixed material was cut either in the coronal or in the axial plane along the tonotopic axis of A1, on a freezing microtome at 40-80 um. Changes in the density of PV+ cells and MBP were examined by fluorescence immunohistochemistry using standard methods. Tissue was incubated overnight at 4° C. in either monoclonal or polyclonal antisera (dilution: 1:2000; Sigma Chemicals, St. Louis, Mo.; for anti-PV: #P3088; dilution: 1:2000; Chemicon International, Temecula, Calif.; for anti-MBP: MAB1580). After exposing to biotinylated anti-mouse or rabbit IgG (1:100; Vector, Burlingame, Calif.; ABC kit), samples were rinsed and treated further with streptavidin-conjugated Cy3 (red) (1:200; Jackson ImmunoResearch Lab., West Grove, Pa.). Tissue from young and aged rats were always processed together in pairs during immunostaining procedures to limit variables relate to antibody penetration, incubation time, and post-sectioning age/condition of tissue (Maciag et al., 2006). Similar approach was also conducted for aged and aged-trained rat brain tissues. A Nikon E800 epifluorescent microscope was used to assess fluorescence in the immunostained material. An imaging system equipped with a Photometrics Coolsnap ES CCD camera (Roper Scientific, Duluth, Ga.) and Metamorph imaging software (Molecular Devices Systems, Toronto, ON) was used to quantify data. PV+ cell density was evaluated in three 300 um wide A1 sectors (rostral, middle and caudal) per hemisphere expending from layer 1 to the underlying white matter. Images were acquired from non-recorded hemispheres/case, keeping exposure time constant for each series of tissue. From these images, the total numbers of PV+ cells in each cortical section was calculated and averaged. In brief, a total of 30 (young: 14; aged: 10; aged-T: 6) cortical hemispheres were examined.

In order to semi-quantitatively analyze alterations in MBP density that was attributable to aging and aging-training, digital photomicrographys of A1 cortical sections were taken with a 10× objective. For a given case, 2-3 tissue sections were photographed through each target areas. The images were first “flattened/skeletonized” to more readily distinguish objects of interest from background. A “threshold” overlay was then applied to each image in order to delineate the MBP fiber density. In the analysis of MBP immunostaining density, the “percentage of thresholded area” was determined for each image. Two cortical subregions were semi-quantitatively analyzed. The first zone was centered in layer I (95 um×700 um), and the second zone was aimed at layers II and III (215 um×700 um). Three samples were obtained per section. As for the number of Olg+ cells, an area (1 mm×1 mm) from the pial surface of the A1 with a 20× objective was randomly chosen and then analyzed. Data were then recorded as an average value for each case, statistical analysis was then performed. In brief, a total of 18 (young: 6; aged: 6; aged-T: 6) cortical hemispheres were examined.

Data Analysis

The characteristic frequency (CF) of a cortical site was defined as the frequency at the tip of the tuning curve. When a tuning curve had a broad tip or multiple peaks, the median frequency at the threshold intensity was chosen as the CF. Response bandwidths 10 dB above threshold (BW10) were defined for all sites. For multipeaked tuning curves, the response bandwidth was defined as the range from the lowest to the highest frequency at 10 dB about the most sensitive tips that activated the cortical site, possibly encompassing the frequencies in a trough of the tuning curve that did not activate the cortical neurons. The CF, threshold and BW10 were determined by direct visualization of the tuning curve in the MatLab environment (The MathWorks Inc., Natick, Mass.) using custom routines.

Normalized responses to standard and oddball tones were obtained by dividing the average firing rate recorded in the 50 ms after the occurrence of each tone presentation against the average firing rate observed during the 50 ms after the first standard or oddball tone in the sequence. Asymptotes and time constants (τ_{1/2}) for standard and oddball responses were calculated by fitting exponential functions to the normalized response data for each recorded neuron.

To generate cortical maps, Voronoi tessellation (“voronoi” is a Matlab function; The Mathworks, Inc.) was performed to create tessellated polygons, with the electrode penetration sites at their centers. Each polygon was assigned the characteristics (e.g., CF) of the corresponding penetration site. In that way, every point on the surface of the auditory cortex could be linked to the characteristics experimentally derived from a sampled cortical site that was closest to that point. The boundaries of the primary auditory cortex were functionally determined using the following criteria: (1) primary auditory neurons generally have a continuous, single-peaked, V-shaped receptive field, and (2) CFs of the A1 neurons are tonotopically organized with high frequencies represented rostrally and low frequencies represented caudally (Bao S et al. (2003) J Neurosci 23:10765-10775). The normalized tonotopic axis of CF maps was calculated by rotating the map to make horizontal a linear function fit of the penetration coordinates using a least squares method. After rotation, penetrations coordinates were vertically collapsed on and normalized to a 0 to 1 range. The precision in tonotopicity (tonotopic index) for each CF map was assayed by computing the average minimum distance from each data point to the line connecting (0, 0) and (1, 1) after converting the logarithmic frequency range (1-30 kHz) to a linear range (0-1). RF overlap index was computed by first transforming the frequency-intensity response functions of two compared neurons into one-dimensional vectors and then calculating the peak of the normalized cross-correlation between the two vectors produced°. These values were obtained for all permutations of neuron pairs with various inter-neuron distance recorded within a single A1 map.

RRTF data were quantified by determining the number of spikes that arrived within a fixed window (4-45 ms) after tone onset. In this study, the RRTF is the average number of spikes for each of the last seven tones of the eight-tone train plotted as a function of repetition rate. To allow for comparison across sites, normalized spike rates were generated by dividing by the number of spikes in response to a single tone presented in isolation (first tone) (Kilgard, M. P. & Merzenich, M. M. (1999) Hear Res 134:16-28). Normalized spike rates above one indicate facilitation, while rates less than one indicate adaptation of the neural response relative to the response to an isolated tone. The cortical ability for processing high-rate stimuli was estimated with the highest temporal rate at which the RRTF was at least half of its maximum, referred to as F_{h1/2} (Bao S et al. (2004) Nat Neurosci 7:974-981). Asynchronous responses were defined as the average spike rate encountered in a window starting at 45 ms after a noise burst to the time of occurrence of the next burst.

Misclassification rates were calculated using a published spike train distance metric (van Rossum, M. C. (2001) Neural Comput 13:751-763) quantifying the similarity between two spike trains. First, the spike times were converted to spike trains using a resolution of 10 ms. Next, each spike train was convolved with an exponential function, N(t)=N₀e^{-d}τ, to obtain a filtered function. The distance between two spike trains was defined as the integral of the squared difference of the two functions. Distances were computed for all spike trains at different values of τ. For analysis, τ=10 ms was used since it empirically gave the best discriminability. A distance value was computed for every combination of spike trains obtained for the RRTF data for each recorded neuron. Confusion matrices were then constructued by first calculating the average distance and standard deviation between spike trains in response to the same or different pulsed noise stimuli presented at various repetition rates. For spike trains obtained with different stimuli, a misclassification occurred when the distance between the two trains was less than one standard deviation away from the average distance (false negative), for spike trains recorded with identical stimuli, a misclassification occurred when the distance between the two trains was more than one standard deviation away from the average distance (false positive).

Spontaneous neuronal spikes were recorded simultaneously in silence from two to four electrodes for 10 periods of 10 seconds to assess the degree of synchronization between cortical sites. Cross-correlation functions were computed from each electrode pairs by counting the number of spikes coincidences for time lags of −250 to 250 ms with 1 ms bin size and were normalized by dividing each of its bins by the square root of the product of the number of discharges in both spike trains (Brosch, M. & Schreiner, C. E. (1999) Eur J Neurosci 11:3517-3530). The strength of the synchrony was then assessed by computing the average of the CC function from 10 ms preceding to 10 ms past the peak of the function. For neural synchrony recording, offline spike sorting using TDT OpenSorter (Tucker-Davis Technology, Alachua, Fla.) was performed to include only single units in the analysis.

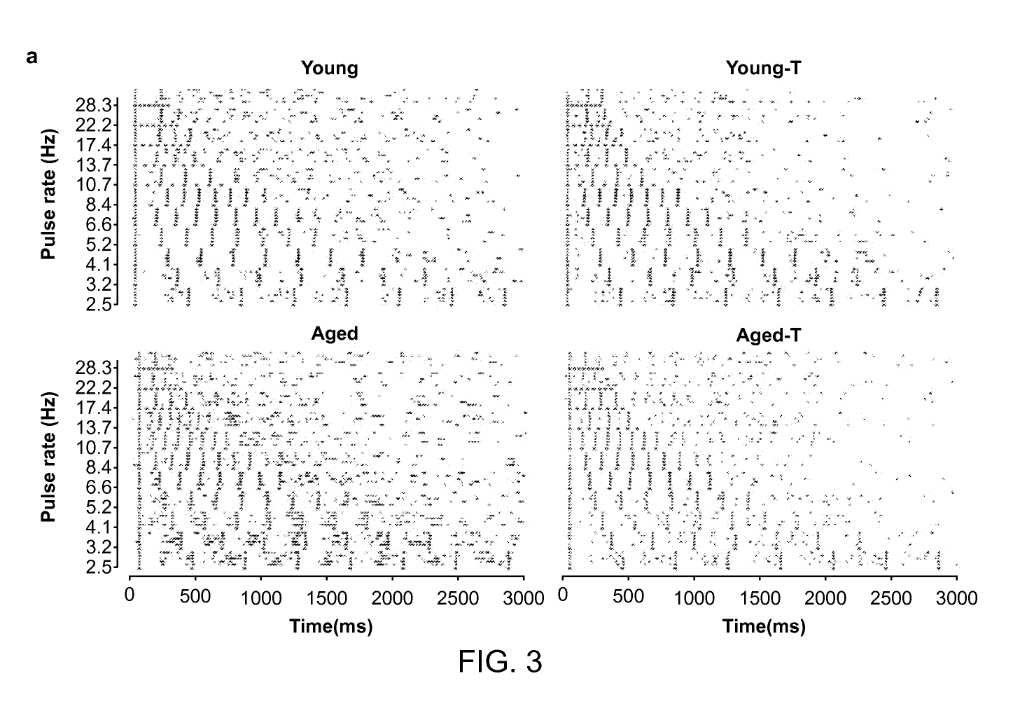

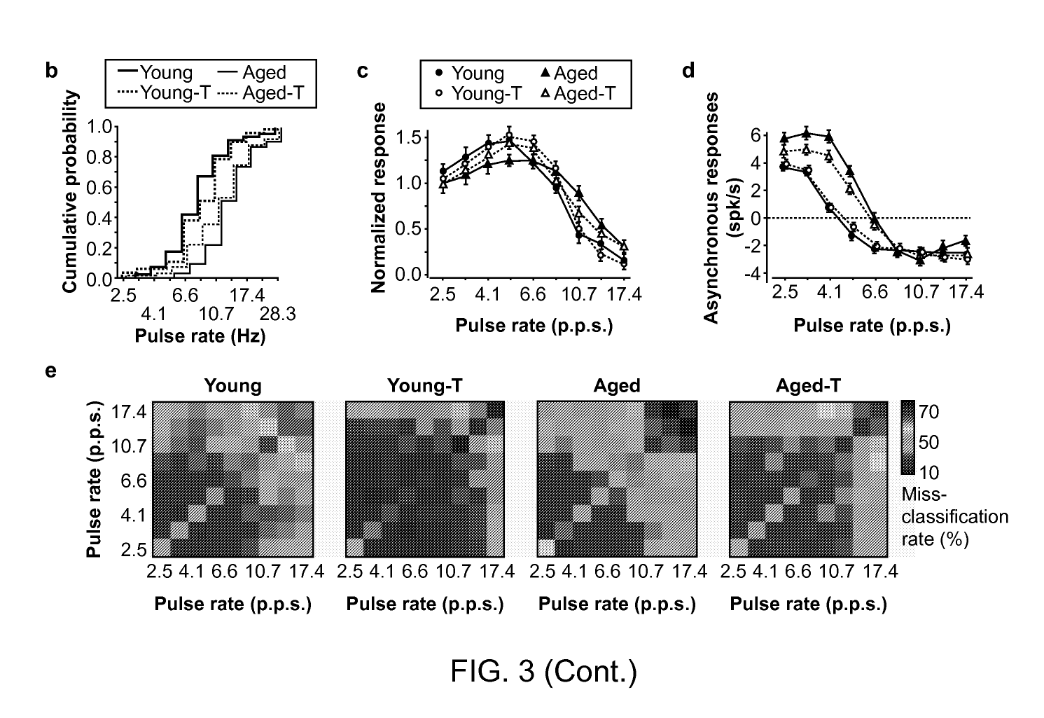

The reverse correlation method was used to derive the spectrotemporal receptive field (STRF), which is the average spectrotemporal stimulus envelope immediately preceding a spike (STA) (Escabi, M. A. & Schreiner, C. E. (2002) J Neurosci 22:4114-4131). Positive (red) regions of the STA indicate that stimulus energy at that frequency and time tended to increase the neuron's firing rate, and negative (blue) regions indicate where the stimulus envelope induced a decrease in firing rate (Supp. FIG. 3). For analysis related to STRFs, only neurons with CFs well within the sound range of the stimulus were used. CF distributions of neurons recorded were similar in the four groups (Supp. FIG. 3). To enable comparisons between neurons each STRF was normalized to the absolute value of peak activation of the STA. Total activation and inhibition strength was then calculated as the integral of the positive or negative area of the STA more than 2 standard deviations away from the baseline. Unless specified otherwise, statistical significance was assessed using unpaired two-tailed t-tests. Data are presented as mean±standard error to the mean (s.e.m).

### Example 1

### Auditory Oddball Detection Performance and Training

Young (n=5) and aged (n=5) rats were trained using an auditory oddball discrimination task to assess the reversibility of A1 age-related functional and physical changes observed in healthy naïve aged rats (n=12). In this Go-NoGo behavioral paradigm, rats were rewarded for correctly identifying the presence of a deviant (oddball) tone in a short sequence of otherwise identical (standard) tones presented at 5 pps (pulses per second) (FIG. 1, panel A). The behavioral task followed a staircase procedure with 6 levels of difficulty. Every training block started at level 1. The level was increased when 3 consecutive correct target identifications were made and decreased after one false positive or miss. The difficulty of the task was progressively increased by reducing the frequency difference between the standard and oddball tones from 0.5 octaves (level 1) to 0.02 octaves (level 6). At the end of the training period, a wide range of A1 neural response characteristics were examined in these trained animals and compared to aged-matched controls.

Both young and aged subjects' performances improved steadily over 27-30 one-hour sessions. On average, rats in the young group were able to reach significantly higher difficulty levels in a shorter time span (FIG. 1, panel b). For example, by session 20, the average maximal level reached by young subjects was approximately one level higher than for aged subjects (young vs aged: level 3.9±0.3 vs 2.8±0.3; p=0.05, t-test). At session 27, when performance gains were plateauing, a small but significant difference persisted (young vs aged: level 4.8±0.2 vs 4.0±0.2; p=0.02, t-test).

The most important factor in aged rats' poorer performance was not a failure to identify targets as seen by the similar hit ratios (correct hits over total targets presented) in both groups (FIG. 1, panel c, p>0.2). The poorer performance of aging rats was largely due to a 50% higher false positive rate, which emerged after approximately 10 sessions, when higher-difficulty levels were achieved (FIG. 1, panel d, young vs aged false positive rate: 23.2±2.2 vs 36.9±5.2%; p=0.03, t-test). After 27 training blocks, when the training ended, the inability of aging rats to suppress responses to non-targets had decreased by 50% compared to their initial value but remained significantly higher than in young controls (young vs aged false positive rate: 10.3±1.1 vs 18.1±2.0%; p=0.008, t-test).

### Example 2

### Training-Induced Refinement in A1 Spectral Selectivity

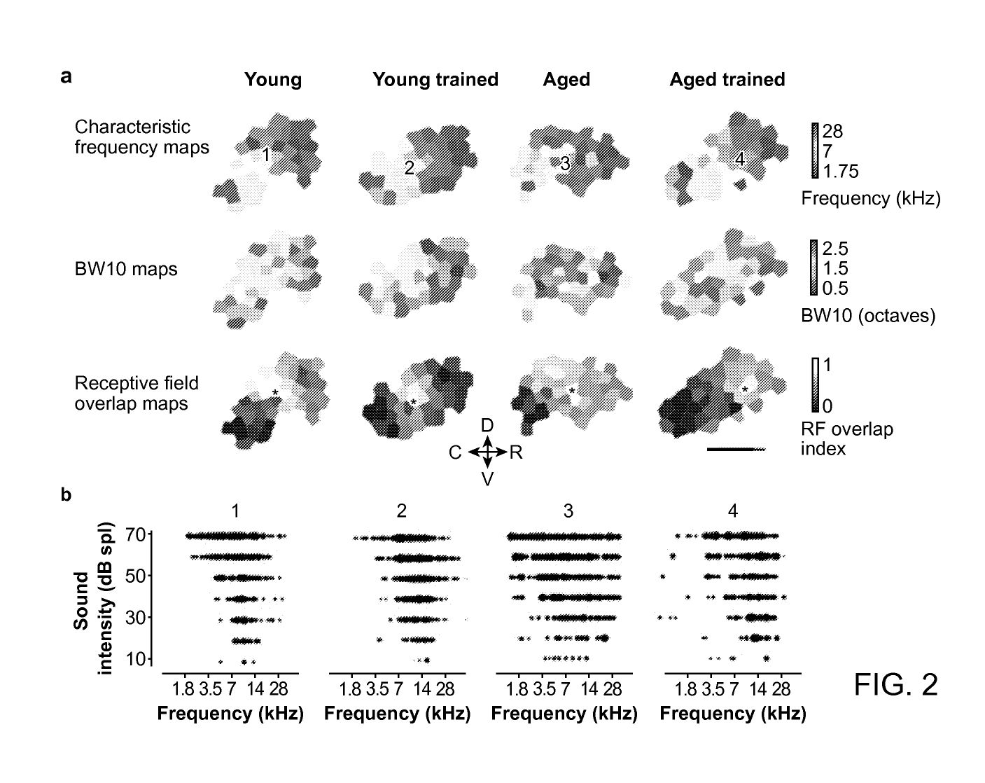

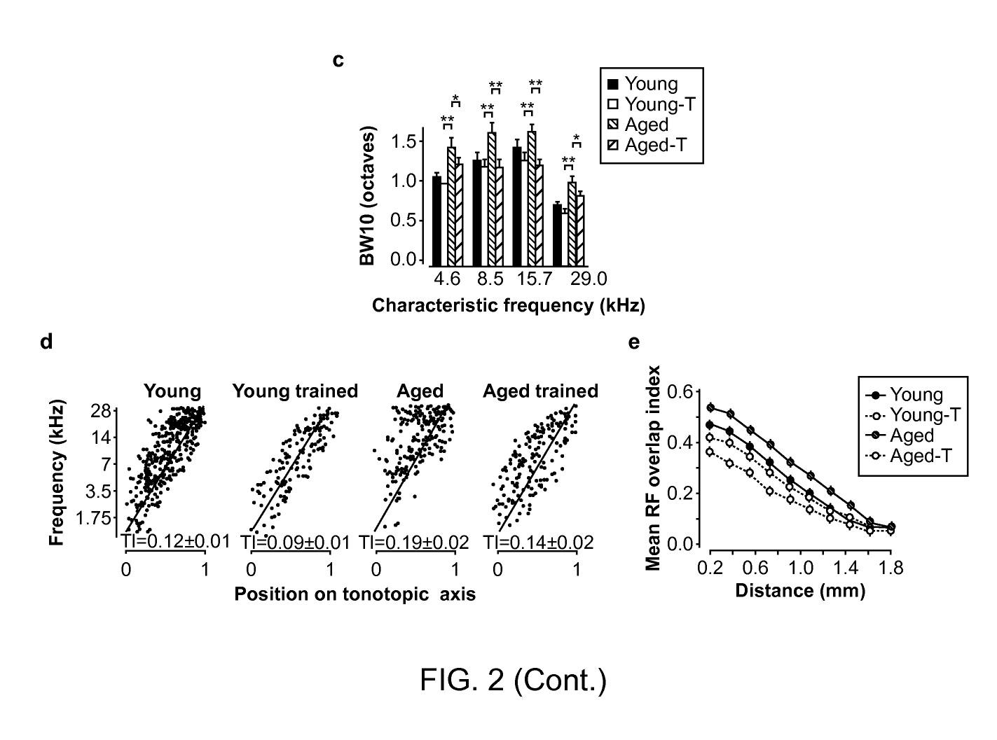

Frequencies are represented in A1 along a continuous rostro-caudal gradient, also known as the “tonotopic axis”. This orderly progression can be distorted or reorganized in adult rats by prolonged peripheral changes such as cochlear damage, or with perceptual training (Rutkowski R G et al. (2005) Proc Natl Acad Sci USA 102:13664-13669; Robertson D et al. (1989) J Comp Neurol 282:456-471; Kilgard M P & Merzenich M M (1998) Science 279:1714-1718). To document age-related changes in A1 frequency representation and their reversal with our training strategy, the frequency-intensity response curves of a dense sample of neurons covering the whole area of A1 in young (n=14), young-trained (n=5), aged (n=12), and aged-trained (n=5) groups were characterized. Representative A1 maps from each experimental group showing characteristic frequency (CF), tuning bandwidth (BW) and receptive field (RF) overlap distribution across A1's cortical area are presented in FIG. 2, panel a.

The frequency selectivity of cortical neurons was significantly reduced in the aged group compared to young controls, with a bandwidth at 10 dB above threshold (BW10) on average 30% broader across the frequency range (young vs aged average BW10 for all CFs: 1.06±0.03 vs 1.42±0.05 octave; p<0.0001, t-test with Bonferroni correction; FIG. 2, panel c). In the aged-trained group, a partial to complete recovery of frequency selectivity (BW10) was observed across the frequency spectrum. While the difference in BW10 in aged trained was significant for neurons tuned to low (1-7 kHz, p=0.02, t-test) and high (16-30 kHz, p=0.04, t-test with Bonferroni correction) frequencies, the reversal was most pronounced in the mid-frequency range (7-16 kHz, p=0.001-0.0001, t-test with Bonferroni correction) where BW10 values were not different than in young and young-trained controls (p>0.2). Despite a trend towards a reduction in BW10 values in the young-trained group, the differences were not statistically significant when compared to age-matched controls (p>0.2).

The orderliness of frequency representation along A1's rostro-caudal axis (tonotopic axis) can be quantified using a tonopic index (TI) that evaluates the degree of scatter in frequency tuning around an ideal logarithmic tonotopic progression (see Methods above) (Zhang L I, Bao S & Merzenich M M (2001) Nat Neurosci 4:1123-1130). Using this measure, CF distribution was found to be significantly disorganized in the aged A1 compared to young controls (TI young vs aged: 0.12±0.01 vs 0.19±0.02; p<0.01, t-test with Bonferroni correction, FIG. 2, panel d). This difference was due mainly to a high proportion of neurons with unusually high CF at the caudal end of A1. Oddball discrimination training significantly reduced A1 CF scatter in young-trained and aged-trained compared to naive groups (p<0.01 and p<0.05, respectively, t-test with Bonferroni correction). Furthermore, after training, the average TI in aged-trained was not statistically different than in untrained young rats (p>0.2).

The frequency selectivity of receptive fields (RF) in A1 has a substantial, direct impact on the spatial resolution of simple sound stimuli. This ‘point resolution’ for the cortex has been earlier employed as an index of cortical “column” size. Here, the extent of spatial activation overlap in A1 was measured for every possible combination of tones and intensities used for mapping. The degree of RF overlap between neuron pairs was obtained by computing the normalized cross-correlation coefficient of the neurons frequency-intensity response curves (RF overlap index (Blake D T et al. (2002) Somatosens Mot Res 19:347-357; see Methods above). The average RF overlap index as a function of interneuron distance is reported for all experimental groups in FIG. 1, panel e. Using this metric, RF overlap was on average at least 20% greater in naïve aged compared to naïve young for inter-neuron distances smaller than 1.6 mm (p=0.01-0.001, t-test with Bonferroni correction). Training resulted in a highly significant reduction in RF overlap index in both trained groups compared to aged matched naïve controls (p=0.0001-0.00001, t-test with Bonferroni correction) over inter-neuron distances less than 1.6 mm and even brought overlap values in old trained below young naives' for short (0-0.4 mm) inter-neuron distances only (p=0.04-0.001, t-test with Bonferroni correction).

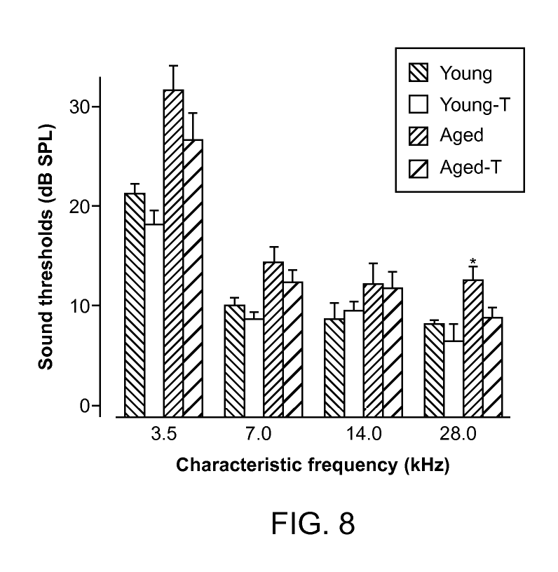

Modest increases in hearing thresholds predominantly for the low and high frequencies as measured by auditory brainstem responses (ABR) has been well documented in aged Brown-Norway rats. In this study, a similar increase in sound detection thresholds at the cortical level was found (FIG. 8). Compared to naïve young controls, hearing thresholds in the aged was also found to be slightly increased for very low and very high frequency-tuned neurons (3.5 kHz, aged vs young difference: 11.3±1.2 dB SPL, p<0.001; 28 kHz, aged vs young difference: 4.5±0.5 dB SPL, p<0.01, t-test with Bonferroni correction). No significant difference was found in the mid-frequency (10-15 kHz) range (p>0.2). Although oddball training had no significant impact on low frequency thresholds, a small statistically significant reduction in threshold back to young levels in aged-trained was observed for the very high frequency range of the auditory spectrum (28 kHz; aged vs aged-trained difference: −3.9±0.4 dB SPL, p<0.05, t-test with Bonferroni correction). Total A1 sizes did not differ between all four groups (p>0.2).

### Example 3

### Role of Successive Signal Modulation in Temporal Processing

The ability of A1 neurons to respond to temporally modulated stimuli has been employed to assess the strengths of successive-signal cortical inhibition. This assay was applied to document the differences in inhibition that plausibly contribute to alterations in rate-following responses in old vs young adult rats before and after training Cortical unit responses evoked by trains of eight noise bursts presented at variable rates in a typical recording series in this study are illustrated by representative raster plots from all experimental groups in FIG. 3.

The temporal following limit of each recorded neuron was quantified as F_{h1/2}, or the repetition rate at which the neuron maintained at least half of its firing rate on average for each noise pulse following the first stimulus event (see Methods above). A1 neurons in the naïve aged group followed significantly faster rates than did neurons in the naive young group (F_{h1/2}, young vs aged: 7.1±0.5 vs 10.5±0.3 pps, p<0.0001, t-test, FIG. 3, panel b). Normalized repetition rate transfer functions (RRTF) were obtained for every recorded cortical site by dividing the average responses to the last seven noise bursts by the average response to the first noise burst. Numbers above 1 indicate an enhancement of the responses to noise bursts; numbers below 1 indicate suppression. The RRTF for slow (2.5 pps) or high (17.4 pps) presentation rates were not significantly different (FIG. 3, panel c) for neuronal populations recorded in naïve young or aged groups. At intermediate rates, however, A1 neurons in the young group displayed a significantly greater modulation of their responses, compared to the aging group. For example, at 4.1 pps, A1 neurons in the young group showed a significant response amplification of 67% compared to less than 20% in the aging group (young vs aged: 1.67±0.09 vs 1.19±0.08 normalized units, p<0.001, t-test with Bonferroni correction). Conversely, at 10.7 pps, neurons in the young group showed a significantly greater attenuation (young vs aged: 0.5±0.04 vs 0.9±0.08 normalized units, p<0.0001, t-test). The differences in the temporal following limit in both groups were proportionally related to the degree of post activation suppression. This is evidenced by the 50% greater number of spikes occurring in the interval between the end of the noise burst-evoked responses and the onset of the following noise burst occurrence (asynchronous responses) for all rates of presentation below 8.4 pps (p=0.001-0.0001, t-test with Bonferroni correction, FIG. 3, panel d).

Oddball discrimination training had a significant impact on successive signal processing in A1. In the aged-trained group, average F_{h1/2} was significantly decreased (aged vs aged-trained: 10.5±0.2 vs 8.8±0.6 pps, p=0.007, t-test) whereas a reverse non-significant trend was found in the young-trained (young vs young-trained: 7.1±0.3 vs 7.8±0.5 pps, p>0.2, t-test with Bonferroni correction). Additionally, a significant increase in response modulation at slow and fast pulse presentation was observed in both trained groups. This is shown in FIG. 3, panel c by the greater response amplification at 5.2 pps and 6.6 pps in aged-trained (p<0.02) and at 6.6 and 8.4 pps young-trained (p<0.05), compared to respective controls. Greater response suppression at higher rates was also observed in the aged-trained group (10.7 pps; aged vs aged trained: 0.9±0.04 vs 0.7±0.05 normalized units, p<0.01, t-test with Bonferroni correction).

The reliability of temporal coding in A1 neurons was then examined in the four experimental groups using a variant of the Van Rossum spike train metric (van Rossum M C (2001) Neural Comput 13:751-763; see Methods above). This method takes into account spike numbers as well as their precise timing to provide a measure of the difference between two spike trains. This measure of difference can then be used to quantify the ease with which an ideal observer would discriminate between the occurrences of different stimuli (here noise burst trains presented at different rates), simply by looking at the response patterns of individual A1 neurons. Misclassification rates for every possible combination of noise burst stimuli used above was calculated, and confusion matrices constructed for all groups (FIG. 3, panel e). Compared to the naive young group, misclassification rates in untrained aging rats were higher for both identical and different stimuli. Differences between the two groups were especially marked when dissimilar high-rate stimuli were presented, in which case spike trains produced by aged neurons showed significantly less difference in spiking patterns than in the untrained young group. For example, for 13.6 vs 17.4 pps, the misclassification rate in the young group was 66.0±1.4% compared to 78.9±2.0% in the aged group (p<0.0001, t-test with Bonferroni correction). Misclassification of identical stimuli as different was also more frequent in the aged group, especially for slow stimulus speeds. For example, at 4.1 pps, the misclassification rate against the same rate in the young group was 28.3±1.4% compared to 37.6±2.3% in the aged group (p<0.001, t-test with Bonferroni correction). Both of these groups performed similarly for comparisons between different stimuli pulsed at 6.6 pps or less (misclassification rates were generally below 20%).

Oddball discrimination training greatly reduced misclassification rates in both aged and young groups as indexed by the spike train metric employed. In aged-trained, the probability of misclassification for combinations of dissimilar high pulse rates (10.7-17.4 pps) were not statistically different from young untrained levels (p>0.2, FIG. 3e). The same was true for the confusability of similar low pulse rates (2.5-6.6 pps), which was also significantly reduced, compared to the aged untrained group (p=0.02-0.001, t-test with Bonferroni correction). In the young-trained group, training significantly reduced the probability of misclassification of pulse rates for most slow or fast pulse rate combinations (p=0.01-0.0001, t-test with Bonferroni correction).

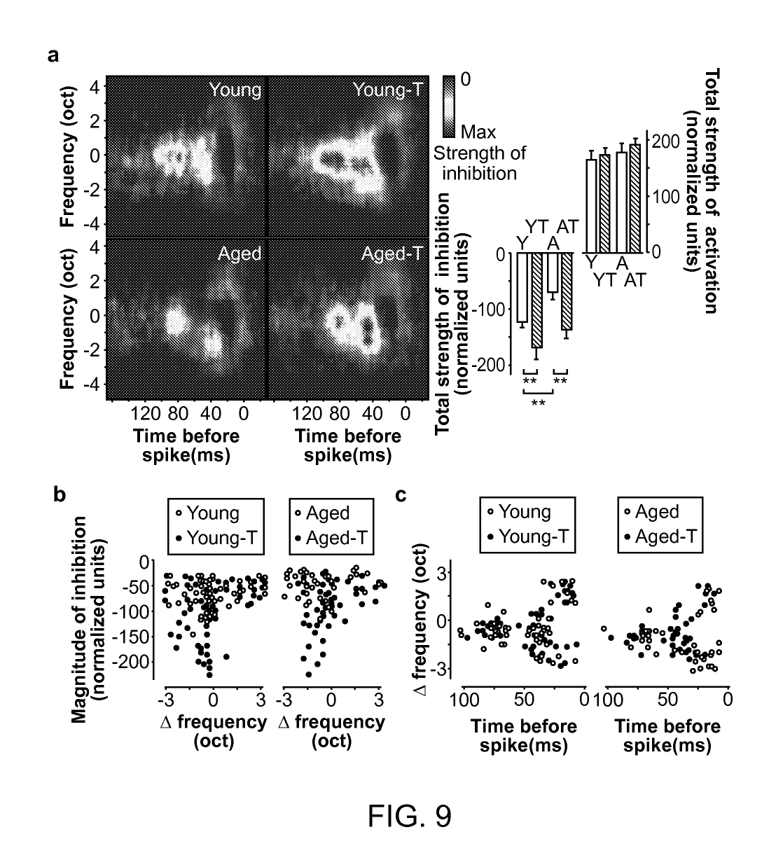

Cortical inhibition in young and aged rats was examined further by constructing the spectrotemporal receptive fields (STRF) of several single neurons in A1 (FIG. 9). The STRFs were obtained with spike-triggered averaging (reverse correlation) and using a “random chord” stimulus containing a spectrally and temporally dense sequence of random tone pips (deCharms R C et al. (1998) Science 280:1439-1443; see Methods above). Representative STRFs obtained in each group are shown in FIG. 10. To compute the average inhibitory strength across each neuron population, the activation peaks of the STRFs were aligned and response intensity was normalized according to the total strength of activation. Then, only the inhibitory portion of the STRF was kept for the analysis. Note that the total activation intensity was not significantly different between each group. Total STRF inhibitory strength was on average 30% less in the naïve aged group compared to the naïve young group (Supp. FIG. 3a, p<0.01, t-test). Furthermore, tone combinations producing peak inhibition were closer in time relative to spike occurrence in the aged (young vs aged peak delay: 55±4 vs 33±9 ms, p<0.05, t-test). No difference was found in the frequency position of the inhibitory peaks relative to activation peaks in any of the groups. Oddball training resulted in a significant increase in total inhibition in both trained groups compared to aged-matched controls. In young-trained, total inhibition was increased by more than 40% (p <0.001, t-test) while it increased by 55% in aged-trained (p<0.001, t-test), whose values were equivalent to young controls (p>0.2). Furthermore, in the aged-trained group, the average inhibitory peak delays matched those found in young groups (aged-trained average inhibitory peak delay: 54±7 ms, p<0.05 relative to naïve aged, t-test).

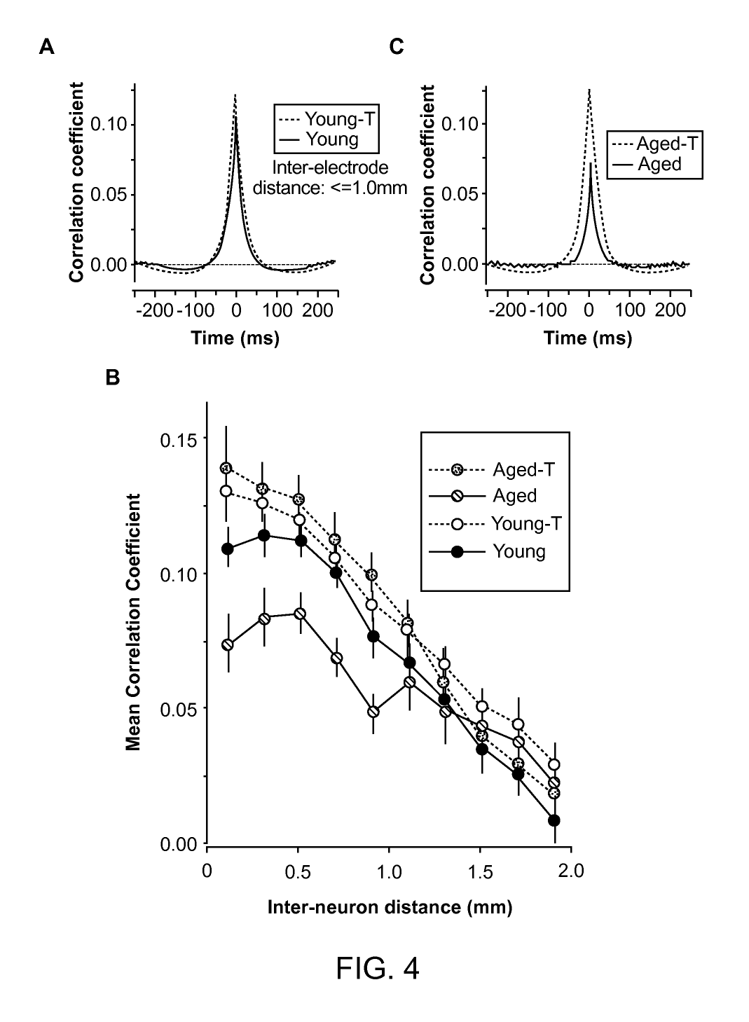

Cortico-cortical interactions were examined by obtaining cross-correlation (CC) functions from the spontaneous discharges of individual A1 neurons at varying inter-electrode distances in young, young-trained, aged and aged-trained rats. Higher CC coefficients infer stronger horizontal projections. CC coefficients were defined as the average of the CC function between −10 and 10 ms time lags. The average CC coefficient for all neurons recorded at an inter-electrode distance of 1 mm or less was 40% lower in the aged group (young vs aged: 0.10±0.002 vs 0.07±0.003; p<0.0001, t-test with Bonferroni correction; FIG. 4, panels a and b). Furthermore, individual CC functions obtained from neuron pairs in the young group were wider than in the aged group (width at half-height of the peak; young vs aged: 29.4±1.4 vs 22.4±2.6 ms; p=0.01, t-test; FIG. 4, panels a and c), and the average minima of these functions, an index of cortico-cortical inhibition, was less (young vs aged: −0.0055±0.0002 vs −0.0031±0.0003; p<0.0001, t-test). Oddball discrimination training resulted in a significant increase in cortical synchrony over short (<1.0 mm) inter-neuron distances in both the aged-trained and young-trained groups. The increase was most pronounced in the aged-trained group which gained average cross-correlation coefficients undistinguishable from young-trained (young-trained vs aged-trained: 0.12±0.002 vs 0.13±0.003; p>0.2). Training also resulted in a doubling of the average CC function minima in the aged group compared to naïve aged (−0.0061±0.0003 normalized units, p<0.0001, t-test) making this value comparable to what was found in young-trained (−0.0065±0.0004 normalized units, p>0.2). Average CC functions half-widths were also found to be equivalent in both trained groups and young naive (p>0.2).

### Example 4

### Improvement in Novel Stimulus Detection with Training

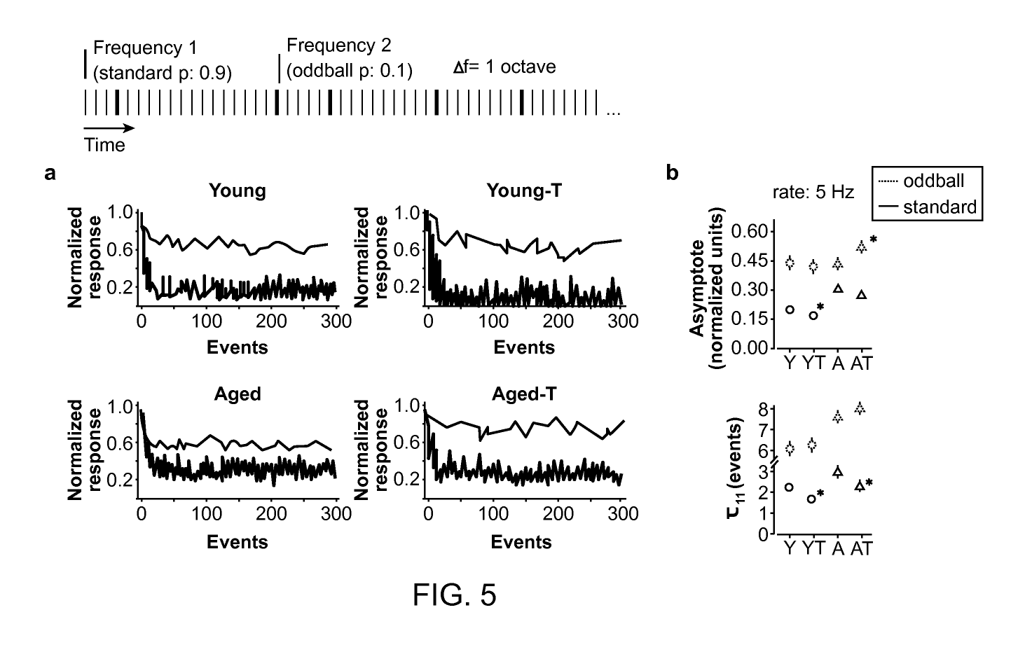

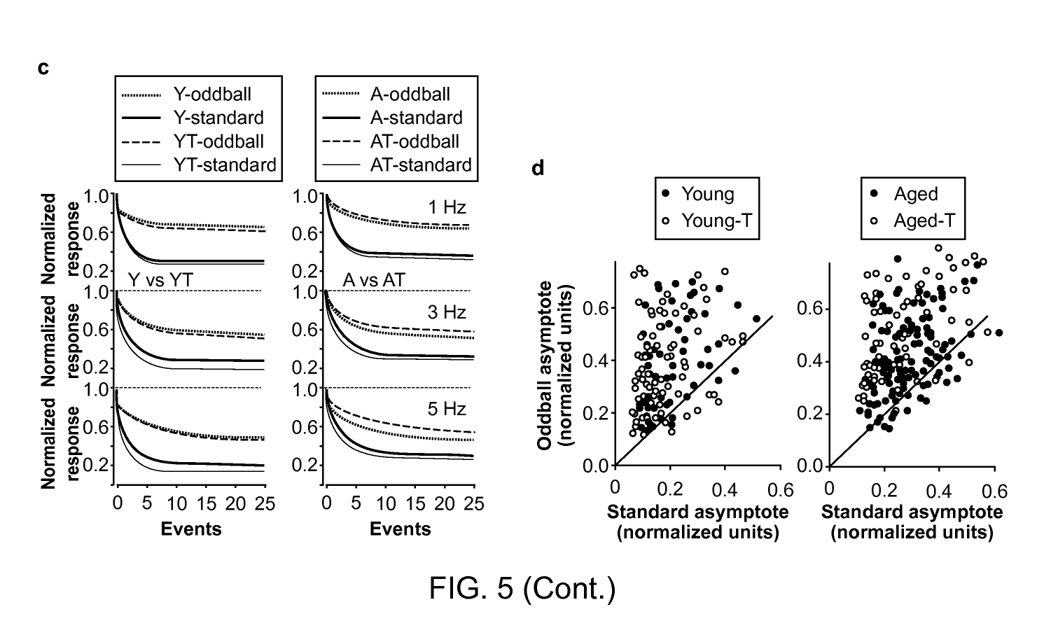

Single neurons in A1 can dramatically increase the salience of novel (oddball) tones by dynamically suppressing their responses to repeated distracters (standards). The effect of normal aging and oddball discrimination training on this property of the cortex was examined by presenting trains of identical, repeated tones and introducing occasional oddball frequencies in the background of these ‘distractors’ while recording neural activity in A1 (see Methods above). Standard tones occurred with a 90% probability; oddballs were presented randomly 10% of the time. Oddballs and standards had matched (60 dB SPL) intensities and 1-octave frequency differences. Neural responses from single neurons or from small clusters of neurons evoked by each tone in the stimulus sequence were recorded at 3 presentation rates (1, 3 and 5 events per second) in both groups (FIG. 5). Exponential functions were fitted to the normalized response rates to oddballs and standard tones in young and aged subjects to obtain a quantitative measure of the rate of decay (expressed as τ_{1/2}) and maximal suppression (asymptote, normalized units) of the neural response to these tones (FIG. 5, panels b, c, and d).

At a relatively slow presentation rate of 1 pps, differences between the young, aged and trained groups were relatively small and non significant. As the rate of stimulus presentation was increased to 3 or 5 pps, however, clear differences emerged between the groups. At 5 pps, neuron responses to standard stimuli in the young group were suppressed within 2 seconds (ten tone pips) to 20% of their initial value, while maintaining significantly stronger responses to random oddballs presented in the same sequence (young; standard vs oddball suppression asymptote: 0.21±0.01 vs 0.45±0.02 normalized units, p<0.0001, t-test). The rate of response suppression was also significantly greater for standard tones (young; standard vs oddball average τ_{1/2}: 2.2±0.1 vs 6.1±0.3 events, p<0.0001). This ability to rapidly increase the salience of infrequent tones was compromised in aged rats. While response suppression to oddballs in this group was similar to neurons in young A1 (0.43±0.02 normalized units, p>0.2), standard suppression was on average limited to 30% of their original response magnitude (0.30±0.01 normalized units), reducing the average gap between standards and oddballs by more than 50% in old rats, when compared to the young group (neuron by neuron average suppression difference between oddball and standard; young vs aged: 0.25±0.03 vs 0.13±0.04 normalized units, p<0.001, t-test). The rate of standard suppression was also approximately 50% slower in the aged group compared to the young group (τ_{1/2} aged: 3.1±0.3, p=0.03, t-test).

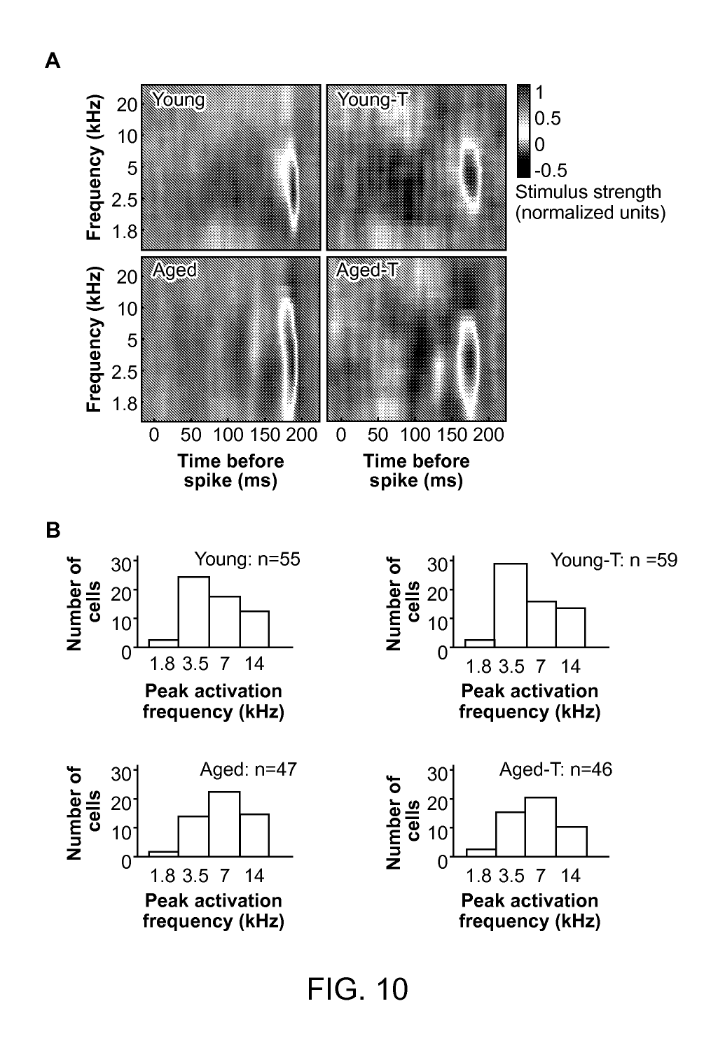

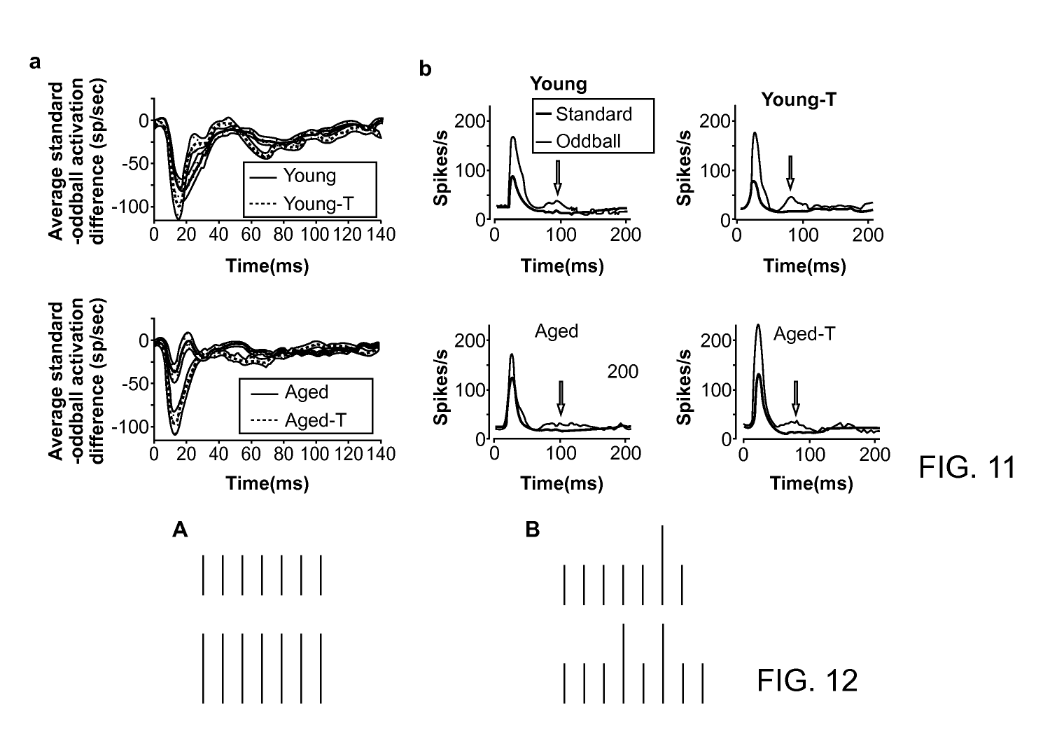

The training used in this study had a different effect on young and aged A1 neurons oddball discrimination abilities. In the young group, training resulted in a small but significant enhanced suppression of standard tones at 5 pps (0.21±0.02 vs 0.16±0.02 normalized units, p<0.05, t-test, FIG. 5b) without any significant change on the response magnitude for oddballs. Examined on a cell-by cell basis, this translated into a small significant increase in oddball vs standard asymptote difference (0.29±0.02 normalized units, p<0.05, t-test). In aged rats, training resulted in an almost complete correction of the oddball vs standard asymptote difference equivalent to what was documented in the young group (aged-trained: 0.22±0.03 normalized units, p<0.001). Interestingly however, unlike in the young group, this response difference was not recovered by increasing standard suppression, which was not significantly different than in the untrained group, but by further releasing responses to oddballs (aged vs aged-t oddball asymptote: 0.43±0.02 vs 0.54±0.03 normalized units, p<0.01, t-test). The positive effect of training effect on stimulus probability coding can also be demonstrated by computing the average difference in area under the curve of individual PSTHs after standard and oddball tones (FIG. 11, panel a). This measure can be though of as an equivalent of mismatch negativity.

Late responses, occurring in the 50 to 100 ms interval following a tone presentation were regularly observed in all experimental groups following the occurrence of an oddball tone. These occurred only very rarely following standard tones. Compared to the young group, the peak of these late responses was later in aged rats (young vs aged: 75±1.3 vs 86±2.9 ms, p<0.001, t-test, FIG. 11, panel b) and their timing was more variable (F_{(138,117)}=5.52: p<0.01, ANOVA). In aged rats, training significantly increased the average peak magnitude of late responses (aged vs aged-t: 6.1±0.4 vs 9.1±0.4 spikes/s above baseline, p<0.00001, t-test) and reduced their latency (aged-t: 79±2.1 ms, p<0.01, t-test) and variance in timing (F_{(117,37)}=6.91: p<0.01, ANOVA). The magnitude of late response was also significantly increased the young-trained group (young vs young-t: 10.4±0.4 vs 12.0±0.6 spk/sec above baseline, p<0.00001, t-test).

### Example 5

### Age-Related Changes in Parvalbumin and Myelin Basic Protein Expression

Parvalbumin positive (PV+) cortical neurons are part of a group of electrically coupled inhibitory inter-neurons comprising fast-spiking (FS) and low threshold spiking (LTS) cells, which play a crucial role in sensory perception and synaptic plasticity. These cells also modulate neural response properties affected by aging such as cortical synchronization and pyramidal cell firing timing precision. Therefore, the number and morphology of PV+ cells were examined in the experimental groups.

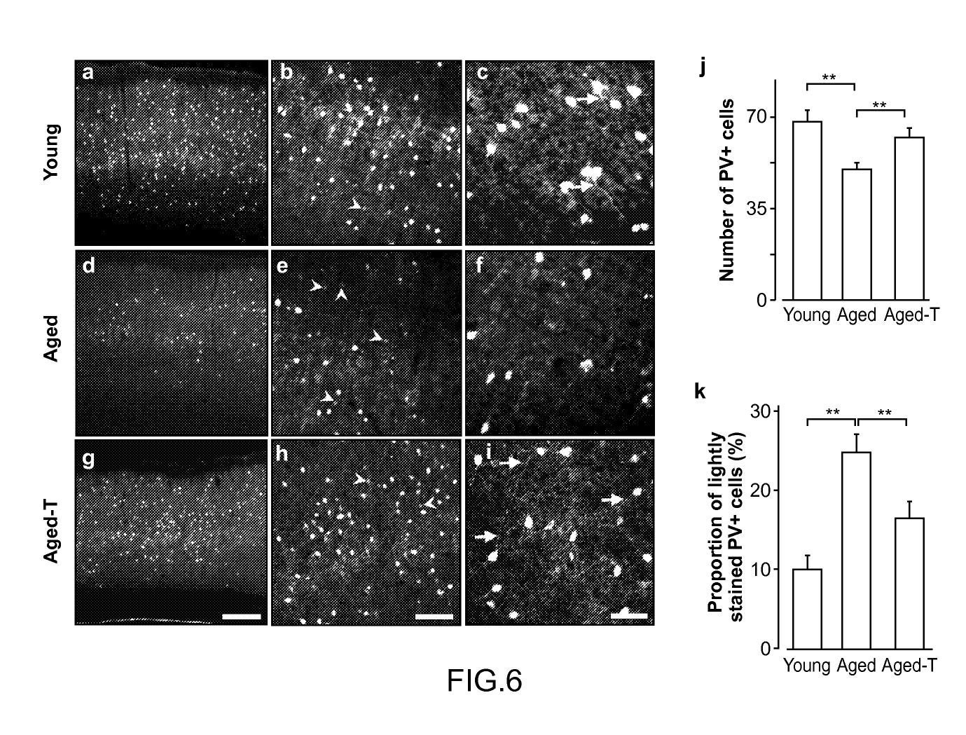

The density of PV+ cells in A1 was quantified using standard immuno-staining techniques by counting all the PV+ cells present within three 300 μm wide A1 sections per hemisphere examined (FIG. 6). An about 25% decrease in PV+ cells counts was found in the aged group compared to the control group (average number of PV+ cells per A1 section; 68.5±2.3 for young; 50.6±2.4 for aged, p<0.001, t-test, FIG. 6, panel j). This decrease was distributed equally across all A1 layers. Additionally, in the aged group, a relatively high proportion of PV+ cells had weak PV expression (average ratio weak/total count; 10.7±0.8% for young; 25.1±2.3% for aged, p<0.001, t-test, FIG. 6, panels b, e, and k) and displayed simplified, less visible dendritic arbors (FIG. 6, panels c, f, and i). Oddball training partially reversed this difference in trained aged rats in which a significant 20% increase in PV+ cells was observed (p<0.05, t-test corrected for multiple comparisons FIG. 6, panel j). Furthermore, fewer cells in aged-trained had weak PV staining compared to the aged group and more visible dendritic arbors (FIG. 6, panels h and i) (average ratio weak/total count; 16.6±0.8%, p=0.002, t-test corrected for multiple comparisons, FIG. 6, panel k). No significant difference was observed between young and young-trained for PV+ cell density or staining intensity.

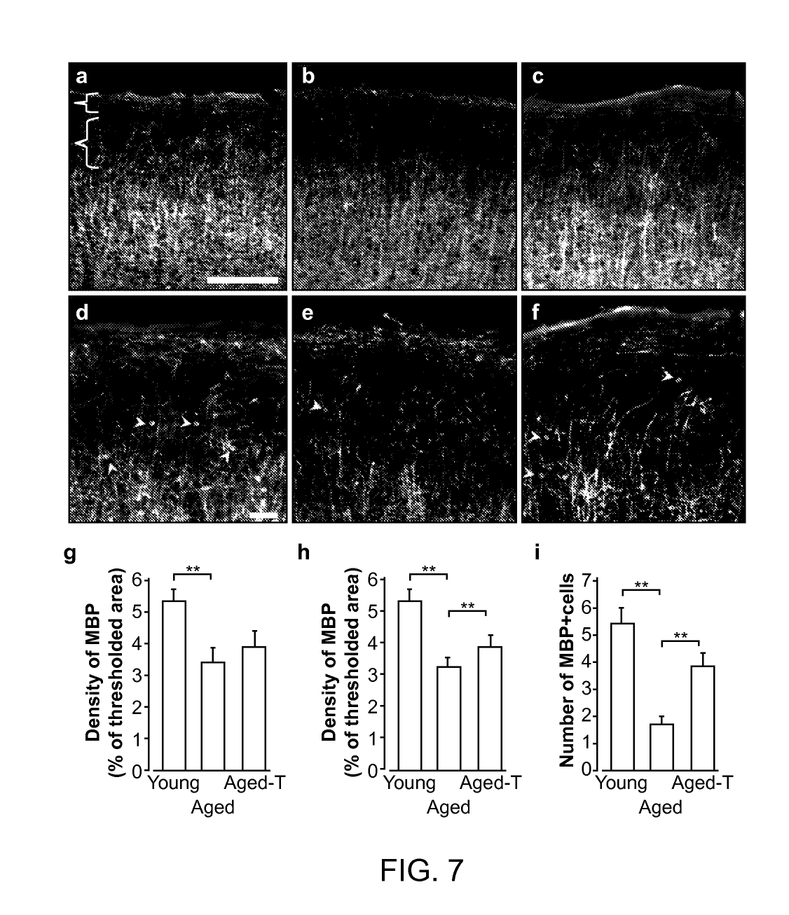

A decrease in subcortical myelin has been shown to occur in healthy human aging. This change is thought to contribute to common age-related cognitive impairments by reducing the velocity and reliability of axonal conduction in long-range cortico-cortical projections. Cortical myelin density was determined in all experimental groups by semi-quantitatively measuring the density of myelin basic protein (MBP) expression in A1, a homogeneously distributed major constituent of myelin. Compared to the young group, a reduction of MBP immunoreactive density was noted in the aged group (FIG. 7). More specifically, a ˜35% decrease in MBP density in the superficial layer I was observed in the aged group compared to the naïve young (averaged MBP density: 5.3=1.5% of threshold area for young; 3.4±1.8% for aged; p<0.05 t-test; FIG. 7, panel g). Similarly, a 38% decrease of MBP density was also noted in layers II and III (4.2±1.3% for young, 2.6±1.0% for aged, P<0.05, t-test; FIG. 7, panel h). As for the oligodendrocyte (Olg), the analysis revealed that a reduced number of Olg immunoreactive cells in layers I-III was found in aged animals compared to young (5.44±1.9 for young, 1.7±1.2 for aged, p<0.001, t-test; FIG. 7, panel i). Interestingly, oddball discrimination training resulted in a relative corrective normalization of MBP levels in the aged-trained group (layers 3.9±1.6% for aged-T; p<0.05, t-test corrected for multiple comparison; layer I: 3.9±2%; did not reach significance; FIG. 7 panels c, f, g, and h). Such recovery in aged trained animals was also applied to the number of Olg immunoreactive cells (3.88±1.8; p<0.05, t-test corrected for multiple comparisons; FIG. 7, panel i).

### Discussion

The present study revealed many auditory processing deficits documented in cortical field A1 in aging vs young adult rats, summarized in Table 1 below. Functional deficits were paralleled by negative structural changes in PV staining inhibitory neurons, and in myelination. These many differences almost certainly contributed to degraded behavioral performance abilities seen in go-no go behavioral tasks in old animals. A1 neurons in older rats had poorer spectral and temporal response selectivity. They had significantly deteriorated “gain control” adjustments (“adaptation”) when they were exposed to repetitive backgrounds. These deficits plausibly contributed to a poorer ability of aged rats to detect novel stimuli, and specifically, would be expected to contribute to a weakness in their suppression of non-target stimuli manifested by higher numbers of false-positive behavioral responses. These impairments appear to relate to the most consistent deficits observed in older humans and show that the Brown-Norway rat is a useful model for studying the detailed cortical mechanisms underlying cognitive aging. Behavioral training in the form of a simple oddball discrimination task resulted in a large-scale reversal of a majority of the observed age-related functional and structural impairments in A1. In conclusion, sensory and behavioral experiences play a determinant role in the etiology of age-related cognitive decline. The study also indicates that powerful plastic potential still exist in the aged brain.

TABLE 1

| | |
|---|---|
| Impact of auditory training on | Reversed with |
| age-related changes in A1 | training |

Spectral

| | |
|---|---|
| Broad receptive fields (BW10) | ++ |
| Increased RF overlap (larger cortical “columns”) | ++ |
| Degraded tonotopic axis | + |
| Higher sound-intensity thresholds | +/− |

Temporal

| | |
|---|---|
| Higher temporal following limit | + |
| Decreased successive signal suppression and | + |
| enhancement | |
| Weaker post-activation suppression | + |
| Weaker side-band inhibition | + |
| Degraded reliability of temporal coding | ++ |
| Decreased cortical firing synchrony | ++ |
| Decreased cortico-cortical inhibition | ++ |
| Decreased suppression of repetitive high probability | +/− |
| sounds | |
| Decreased salience of novel stimulus-evoked responses | ++ |
| Slowed adaptation to repetitive stimuli | + |
| Weak and scattered late responses after low probability | ++ |
| sound | |

Structural

| | |
|---|---|
| Decrease in PV staining | + |
| Low PV expression in PV+ neuron | + |
| Simplification of PV+ cell dendritic arborization | + |
| Decrease in myelin basic protein labeling in the cortex | + |

Behavior

| | |
|---|---|
| Poorer frequency discrimination at the onset of training | + |
| Increased number of false positive responses | + |
| Slower learning rates | N/A |
| Lower asymptotic performance levels | N/A |

The difficulties aged rats encountered during behavioral training relate primarily to an inability to suppress responses to non-targets resulting in a higher frequency of behavioral “false alarms”. This effect is similar to what has been observed in aging human subjects engaged in GoNogo behavioral paradigms (Hasher L et al. (1991) J Exp Psychol Learn Mem Cogn 17:163-169) or selective attention task (Gazzaley A et al. (2005) Nat Neurosci 8:1298-1300). The fact that response rates to targets was not significantly different in aged vs young rats could be tied to the higher false positive rate and should not be interpreted as a preserved ability to distinguish oddball from standard stimuli. Despite their generally poorer performance on the task, aging rats learned task rules as rapidly as did young ones, suggesting they do not suffer from gross learning, memory or motor impairments. It is also important to note that their perceptual performance improved significantly throughout this training paradigm, indicating that mechanisms of plasticity can still drive behaviorally relevant changes in this age group.

Neuronal responses in A1 in aged rats were “de-tuned” (had larger than normal receptive fields) leading to larger, more broadly overlapping neuronal assemblies representing simple sound stimuli. A decrease in spectral selectivity along with the disruption of the tonotopic gradient in A1 degraded the separate representations of confusable sounds in A1. An analogous coarsening in spatial representation in the cortex has been described in the rat and human somatosensory system where two-point discrimination thresholds and the sizes of corresponding cortical receptive fields increase with age. Similar results have also been obtained in V1 in macaques. The origin of these changes is likely to be multifactorial, resulting from a combination of peripheral, and multi-level central changes. Degraded sensory inputs caused by an age-related loss of hair cells in the aging rat cochlea could play a role in the loss of frequency selectivity documented here. On the other hand, there is only a modest (few-decibel) increase in cortical thresholds in aged animals in this ‘wild’ rat strain. Auditory training essentially completely reversed the age difference in A1 frequency selectivity as measured with BW10 and the RF overlap index. Even tonotopic organization significantly recovered with training. Improvements in frequency discrimination thresholds have been observed in young humans training to as similar oddball detection task. Such a profound refinement in A1 responses is unlikely to be due to changes in the periphery or cochlea and indicate that sufficient differentiation exists in the lateral lemniscal and thalamo-cortical systems to allow for precise spectral distinctions in the aged. More likely, this training effect on spectral selectivity represents a functional rearrangement of the RF-shaping cortical inhibitory circuitry, which was found to be potentiated after training.

Peripheral auditory deficits cannot explain the temporal processing abnormalities observed in the aged group. Weakly inhibited neurons following higher modulation rates and displaying less post-activation suppression strongly indicate a degradation in the strengths and time constants of GABAergic inputs in the aging auditory system. Deficits in GABA-mediated function in V1 in aging cats and macaques have been linked to increases in spontaneous activity and decreases in temporal sensitivity of cortical RF. Temporal coding of repetitive stimuli was substantially less precise in aging A1, leading to significantly more errors in modulation rate classification. Those errors appear to be the result of a reduced control over the gain (augmentation or suppression) of neural responses to repetitive stimuli (flattened RRTF), and to an increase in the number of neural responses that are not precisely time-locked to these periodic stimuli. Both effects likely arise from dysfunctional GABAergic processes. Oddball training had a significant positive impact on the precision of rate coding in both young and aged rats. While temporal following limits and asynchronous responses where slightly corrected in trained aged rats, the improvement was small albeit significant. The effect on response modulation was clearer, and could be the major contributor in the restoration of temporal selectivity in the aged A1. Temporal tuning is a plastic cortical filter shaped by operant training. The tone sequences used for the training presented herein were presented at a constant 5 pps, presumably driving the decrease in temporal following limit in the aged. Both thalamocortical synapses and intra-cortical inhibitory circuit are responsible for temporal tuning in the cortex. In this study, changes in cortical inhibition are more likely to be at play since an increase in response latencies, which usually accompany lower thalamo-cortical transmission potency was not observed. A decrease in the number of asynchronous responses was also observed in the aged-trained. Inhibitory spectro-temporal interactions were restored in the aged A1 by training. The broad increase in STRF inhibitory depth and area in the trained groups is a further indication that training resulted in greater A1 neurons stimulus specificity. Inhibitory areas observed in STRFs have been speculated to result from greater excitatory than inhibitory synapse depression and is linked to probe stimulus density. The precise location in the auditory axis of the change in excitatory-inhibitory balance we observed will be difficult to pinpoint until recordings in subcortical nuclei are performed.

A1 neural firing was found to be less correlated in aged rats. Cortical synchrony is largely mediated through horizontal projections under the influence of specific classes of inhibitory interneurons, including PV-positive fast-spiking cells. These neurons, which are strongly modulated by cholinergic projections from the basal brain nuclei⁷¹ had simplified dendritic arborizations and expressed low amounts of PV in aged rats. The significant decrease in MBP staining in the aging cortex could also contribute to cortical desynchronization by adding jitter to cortico-cortical transmissions. The age-related decrease in peak cortical synchrony was accompanied by significantly decreased cortico-cortical suppression, evidenced by higher average minima of cross-correlation functions. A number or cortical parameters can affect A1 neural synchrony, which is in general higher with greater receptive fields overlap, providing that cortico-cortical projections efficiency is constant. The complete recovery of intracortical correlation simultaneously with significant RF resharpening implies that cortico-cortical transmission adjustments are tied to the establishment and recovery of this age-related change. This idea is further strengthened by the positive changes in PV and MBP expression observed after training.

In aged subjects, adaptation to repeated, identical stimuli—and the proportional responses to “oddball” stimuli presented against a repeated-stimulus background—were weaker, especially at higher stimulus rates. Age-related deficits in novel stimulus perception have previously been extensively documented in the human auditory system using a variety of oddball detection paradigms and non-invasive electro-encephalography strategies, such as mismatch negativity (MMN). These studies have shown that novel stimulus detection in the cortex of aging individuals is less effective, especially when the stimuli used are presented in rapid succession, or when they are more confusable with (differ less from) the standard stimulus. The data presented here are consistent with those previous results, and provide further insight on the mechanisms involved in this common perceptual deficit. Studies based on MMN are limited by their reliance on the difference in signal elicited by novel stimuli compared to that of a steady background, making it difficult to disambiguate if poor oddball detection is due to weak cortical activation or weak distracter suppression (or both). The study here showed in a rodent model that age-related oddball discrimination impairment is primarily due to a slowed and incomplete suppression of (‘adaptation’ to) background distracters. Cortical activation related to an oddball occurrence was largely preserved. A degraded ability to dynamically adjust neural responses to incoming stimuli based on their contextual salience increased the likelihood of falsely labeling distracters as oddballs, and vice versa. This processing anomaly in the aged cortex could be central to emergence of interference sensitivity, a central symptom of age-related cognitive dysfunction.

In young trained, greater oddball salience was obtained by a further suppression of background distracters. In the aged trained, while the rapidity of standard suppression was improved, lesser oddball suppression was the main contributor to a normalization of oddball to standard ratios back to young naïve levels. This dissociation is congruent with the minimal change in temporal following limit observed in aged-trained and indicate that our training strategy was only partially effective in restoring cortical inhibition in that group. Improved oddball salience might have been obtained primarily by the re-establishment of frequency selectivity in A1. Cortically based changes are most likely at the origin of this improvement as sound probability coding is not seen at the level of the thalamus.

In human electro-encephalographic recordings, unexpected auditory and visual stimuli consistently elicit late neural responses, also known as P3a and P3b approximately 200-300 ms after stimulus onset. With age, the latency of these progressively increases and their amplitude diminishes. In rats, similar oddball-driven late responses referred to as “P2” and “P3”, can be recorded over A1 and occur 100 to 240 ms after an oddball stimulus. While the rat P3 and human P3b appears to depend on attention and wakefulness, the earlier rat P2 component like the human P3a, is task irrelevant can even be observed during deep anesthesia. The P3a is though to represent stimulus-driven frontal lobe activity projecting to the temporo-parietal areas. The late responses observed in A1 in this study are close in latency to the rat P2 and occurred only after oddball tones. Furthermore, these responses also showed an age effect with significantly longer latencies, smaller amplitudes and decreased reliability in the aged group. These responses represent a form of “top-down” feedback generated after an unusual or surprising event. Oddball discrimination training was very efficient at reducing their latency and increasing their amplitude in both trained groups. Not only this suggests that A1 is more apt at detecting oddball sound after training, it also indicates that long-range tracts to and from A1 may have become more reliable after training.

High noise levels in the auditory stream of information can have widespread repercussions on noise-sensitive cognitive processes such as memory encoding or predictive sensory biasing via top-down influences. Disinhibited, uncoupled cortical columns and dysfunctional cortical filters in the aged A1 such as seen in this study probably results in “noisy” non-specific information being fed to downstream cortical areas which will in turn be able to provide only poorly selective top-down feed-back.

Environmental factors could have played a role in the emergence of A1 age-related deficits seen in this study. The auditory environment in which naïve rats were kept until the time of mapping was probably not as rich and intellectually challenging as a natural habitat. While controlling for this possibility would be important in future experiments, there is strong evidence that aging humans rarely engaged in cognitively stimulating activities are at higher risk of developing cognitive impairments at an earlier age. This raises the possibility that in humans like in rats, a chronically reduced level of meaningful challenging intellectual activity might be a significant etiological factor in age-related cognitive decline. In fact, the widespread improvements we observed in aged rats after auditory oddball training—a controlled form of intensive sensory enrichment—is a clear indicator that rewarding intellectual activity can have strong up-regulating effects on cortical function.

One of the most striking findings of this study is that every aspect of sound processing examined in the aging A1 was degraded- and then substantially reversed with a very simple training strategy. Realizing that literally hundreds of different molecular and structural elements are needed to support these cortical processes, it is very unlikely that purely random independent events are the cause of their “degeneration” with age. Rather, these deficits are the result of a tightly orchestrated down-regulation of the cortical machinery, in response to significant changes in experience-dependent brain activity. As such, new specific, evidence-based training strategies coupled with ongoing behavioral enrichment could become powerful therapeutic tools to combat the brain changes that we normally associate with aging.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of training for enhancing cognition in an individual comprising:
presenting to said individual multiple sets of stimuli, wherein each set of said multiple sets comprises two or more identical stimuli and wherein at least one set of said multiple sets comprises an anomalous stimulus;
receiving an input from said individual that has been instructed to only respond to said anomalous stimulus in a set; and
repeating said presenting and said receiving steps as a cycle and repeating said cycle with a selected time interval in between cycles;
wherein if said input is correct, a subsequent cycle has a higher difficulty level than a previous cycle, and
wherein if said input is incorrect, a subsequent cycle has the same or lower difficulty level,
wherein said method enhances cognition in said individual.

2. The method of claim 1, wherein anomalous stimulus is presented to said individual prior to said presenting step.

3. The method of claim 1, wherein said multiple sets are presented in a continous stream.

4. The method of claim 1, wherein difficulty level is varied by varying pulse per section or onset-to-onset time.

5. The method of claim 1, wherein
if there is a correct input in a first cycle, differences between said identical stimuli and said anomalous stimulus in a set are decreased in a second cycle relative to a first cycle; and
if there is an incorrect input in a first cycle wherein said differences are increased or remain the same.

6. The method of claim 1, wherein if the percentage of correct or incorrect responses is equal or greater than a selected threshold, said repeating is terminated.

7. The method of claim 1, wherein said repeating is terminated after about 60 minutes.

8. The method of claim 1, further comprising generating an output to said individual after said receiving said input.

9. The method of claim 8, wherein if said input is correct, said output is a reward.

10. The method of claim 8, wherein if said input is incorrect, said output is a penalty.

11. The method of claim 1, wherein said stimuli are auditory.

12. The method of claim 11, wherein said anomalous stimulus differ in frequency, loudness, or timbre.

13. The method of claim 1, wherein said stimuli are visual.

14. The method of claim 13, wherein said anomalous stimulus differ in color, shape, size, texture, orientation, or motion.

15. The method of claim 11, wherein said stimuli is a combination of auditory and visual stimuli.

16. The method of claim 1, wherein each of said multiple sets comprises at least 6 stimuli.

17. The method of claim 16, wherein if said set comprising at least 6 stimuli is a target set, an anomalous is presented at position 3 or thereafter in said set.

18. A computer accessible memory medium comprising program instructions for enhancing cognition in a subject, wherein said execution of said instructions causes a device to perform the method of claim 1.

19. A method of training for enhancing cognition in an individual comprising:
executing instructions using a computer system to present to said individual multiple sets of stimuli, wherein each set of said multiple sets comprises two or more identical stimuli and wherein at least one set of said multiple sets comprises an anomalous stimulus; and
receiving an input electronically from said individual that has been instructed to only respond to said anomalous stimulus in a set, and
repeating said executing and said receiving steps as a cycle and repeating said cycle with a selected time interval in between cycles,
wherein if said input is correct, a subsequent cycle has a higher difficulty level than a previous cycle, and
wherein if said input is incorrect, a subsequent cycle has the same or lower difficulty level,
wherein said method enhances cognition in said individual.

20. The method of claim 19, further comprising executing instructions using a computer to generate an output to said individual after said receiving said input.

21. A computer-readable storage medium, comprising instructions executable by at least one processing device that, when executed, cause the processing device to:
(a) present to an individual with multiple sets of stimuli, wherein each set of said multiple sets comprises two or more identical stimuli, and wherein at least one set of said multiple sets comprises an anomalous stimulus;
(b) receive an input from said individual;
(c) repeat said presenting and said receiving as a cycle;
(d) repeat said cycle with a selected time interval in between cycles; and
(e) determine if a subsequent cycle should have a higher difficulty level or a lower difficulty level based on the received input.

22. The computer-readable storage medium of claim 21, further comprising instructions executable by at least one processing device that, when executed, cause the processing device to present said multiple sets in a continuous stream.

23. The computer-readable storage medium of claim 21, further comprising instructions executable by at least one processing device that, when executed, cause the processing device to vary the difficulty level by varying pulse per section or onset-to-onset time.

24. The computer-readable storage medium of claim 21, further comprising instructions executable by at least one processing device that, when executed, cause the processing device to generate an output to said individual based on the input.

25. The computer-readable storage medium of claim 23, wherein said output is a reward.

26. The computer-readable storage medium of claim 23, wherein said output is a penalty.

27. The computer-readable storage medium of claim 21, wherein said stimuli are auditory.

28. The computer-readable storage medium of claim 26, wherein said anomalous stimulus differ in frequency, loudness, or timbre.

29. The computer-readable storage medium of claim 21, wherein said stimuli are visual.

30. The computer-readable storage medium of claim 28, wherein said anomalous stimulus differ in color, shape, size, texture, orientation, or motion.

31. The computer-readable storage medium of claim 21, wherein said multiple sets comprises at least 6 stimuli.

32. The computer-readable storage medium of claim 30, wherein if said set comprising at least 6 stimuli is a target set, an anomalous is presented at position 3 or thereafter in said set.
